(19) United States
(12) Patent Application Publication
(10) Pub. No.: US 2025/0208820 A1
(43) Pub. Date: Jun. 26, 2025

(54) REMOTE USER-INTERFACE VIEWS

(71) Applicant: Apple Inc., Cupertino, CA (US)

(72) Inventors: Antony J. DZERYN, Round Rock, TX (US); Nicholas J. CIRCOSTA, Mountain View, CA (US); Gina LU, San Jose, CA (US); Kartik R. VENKATRAMAN, San Francisco, CA (US)

(21) Appl. No.: 19/081,389

(22) Filed: Mar. 17, 2025

Related U.S. Application Data
(63) Continuation of application No. 18/653,599, filed on May 2, 2024, now abandoned.
(60) Provisional application No. 63/464,534, filed on May 5, 2023.

(51) Int. Cl. G06F 3/14; G06F 3/0486; G06F 9/451

(52) U.S. Cl. CPC G06F 3/1462; G06F 9/452; G06F 3/0486

(57) ABSTRACT

Some techniques are described herein for managing user-interface views on different devices.

### CROSS-REFERENCE TO RELATED APPLICATIONS

The present application is a continuation application of U.S. Non-Provisional patent application Ser. No. 18/653,599, entitled “REMOTE USER-INTERFACE VIEWS,” filed May 2, 2024, which claims priority to U.S. Provisional Patent Application Ser. No. 63/464,534, entitled “REMOTE USER-INTERFACE VIEWS” filed May 5, 2023, which are hereby incorporated by reference in their entireties for all purposes.

### BACKGROUND

Electronic devices are becoming increasingly prevalent. Such electronic devices are often connected with each other and communicate data to be displayed. Using current techniques, managing such display of data is often inefficient and/or ineffective. Accordingly, there is a need to improve techniques for managing display of data on different devices.

### SUMMARY

Current techniques for managing user-interface views on different devices are generally inefficient and/or ineffective. For example, some techniques require users to share their screen and/or are limited to applications executing on a particular device. This disclosure provides more effective and/or efficient techniques for managing user-interface views on different devices using an example of a source device communicating with a remote device. It should be recognized that such techniques optionally complement or replace other techniques for managing user-interface views on different devices.

Some techniques are described herein to allow a source device to drive interactions with and/or display of content in a separate context (e.g., on a remote device) from where the content is rendered and/or serviced. For example, some techniques described herein decouple presentation of content from production of content. This can allow users to bring their identity and/or data on a source device to a remote device.

In some examples, a method that is performed at a first computer system is described. In some examples, the method comprises: sending, to a second computer system different from the first computer system, a list of available applications; after sending the list of available applications, receiving, from the second computer system, a list of selected applications from the list of available applications; in response to receiving the list of selected applications and in accordance with a determination that a relationship between the first computer system and the second computer system meets a first set of one or more criteria, sending, to the second computer system, a first list of version identifiers corresponding to each application in the list of selected applications; after sending the first list of version identifiers, receiving, from the second computer system, a communication; and in response to receiving the communication: in accordance with a determination that the communication includes a third list of version identifiers corresponding to a respective application in the list of selected applications, sending, to the second computer system, data corresponding to the respective application; and in accordance with a determination that the communication includes a confirmation that the first list of version identifiers matched a second list of version identifiers of the second computer system, forgoing sending, to the second computer system, the data.

In some examples, a non-transitory computer-readable storage medium storing one or more programs configured to be executed by one or more processors of a first computer system is described. In some examples, the one or more programs includes instructions for: sending, to a second computer system different from the first computer system, a list of available applications; after sending the list of available applications, receiving, from the second computer system, a list of selected applications from the list of available applications; in response to receiving the list of selected applications and in accordance with a determination that a relationship between the first computer system and the second computer system meets a first set of one or more criteria, sending, to the second computer system, a first list of version identifiers corresponding to each application in the list of selected applications; after sending the first list of version identifiers, receiving, from the second computer system, a communication; and in response to receiving the communication: in accordance with a determination that the communication includes a third list of version identifiers corresponding to a respective application in the list of selected applications, sending, to the second computer system, data corresponding to the respective application; and in accordance with a determination that the communication includes a confirmation that the first list of version identifiers matched a second list of version identifiers of the second computer system, forgoing sending, to the second computer system, the data.

In some examples, a transitory computer-readable storage medium storing one or more programs configured to be executed by one or more processors of a first computer system is described. In some examples, the one or more programs includes instructions for: sending, to a second computer system different from the first computer system, a list of available applications; after sending the list of available applications, receiving, from the second computer system, a list of selected applications from the list of available applications; in response to receiving the list of selected applications and in accordance with a determination that a relationship between the first computer system and the second computer system meets a first set of one or more criteria, sending, to the second computer system, a first list of version identifiers corresponding to each application in the list of selected applications; after sending the first list of version identifiers, receiving, from the second computer system, a communication; and in response to receiving the communication: in accordance with a determination that the communication includes a third list of version identifiers corresponding to a respective application in the list of selected applications, sending, to the second computer system, data corresponding to the respective application; and in accordance with a determination that the communication includes a confirmation that the first list of version identifiers matched a second list of version identifiers of the second computer system, forgoing sending, to the second computer system, the data.

In some examples, a first computer system is described. In some examples, the first computer system comprises one or more processors and memory storing one or more program configured to be executed by the one or more processors. In some examples, the one or more programs includes instructions for: sending, to a second computer system different from the first computer system, a list of available applications; after sending the list of available applications, receiving, from the second computer system, a list of selected applications from the list of available applications; in response to receiving the list of selected applications and in accordance with a determination that a relationship between the first computer system and the second computer system meets a first set of one or more criteria, sending, to the second computer system, a first list of version identifiers corresponding to each application in the list of selected applications; after sending the first list of version identifiers, receiving, from the second computer system, a communication; and in response to receiving the communication: in accordance with a determination that the communication includes a third list of version identifiers corresponding to a respective application in the list of selected applications, sending, to the second computer system, data corresponding to the respective application; and in accordance with a determination that the communication includes a confirmation that the first list of version identifiers matched a second list of version identifiers of the second computer system, forgoing sending, to the second computer system, the data.

In some examples, a first computer system is described. In some examples, the first computer system comprises means for performing each of the following steps: sending, to a second computer system different from the first computer system, a list of available applications; after sending the list of available applications, receiving, from the second computer system, a list of selected applications from the list of available applications; in response to receiving the list of selected applications and in accordance with a determination that a relationship between the first computer system and the second computer system meets a first set of one or more criteria, sending, to the second computer system, a first list of version identifiers corresponding to each application in the list of selected applications; after sending the first list of version identifiers, receiving, from the second computer system, a communication; and in response to receiving the communication: in accordance with a determination that the communication includes a third list of version identifiers corresponding to a respective application in the list of selected applications, sending, to the second computer system, data corresponding to the respective application; and in accordance with a determination that the communication includes a confirmation that the first list of version identifiers matched a second list of version identifiers of the second computer system, forgoing sending, to the second computer system, the data.

In some examples, a computer program product is described. In some examples, the computer program product comprises one or more programs configured to be executed by one or more processors of a first computer system. In some examples, the one or more programs include instructions for: sending, to a second computer system different from the first computer system, a list of available applications; after sending the list of available applications, receiving, from the second computer system, a list of selected applications from the list of available applications; in response to receiving the list of selected applications and in accordance with a determination that a relationship between the first computer system and the second computer system meets a first set of one or more criteria, sending, to the second computer system, a first list of version identifiers corresponding to each application in the list of selected applications; after sending the first list of version identifiers, receiving, from the second computer system, a communication; and in response to receiving the communication: in accordance with a determination that the communication includes a third list of version identifiers corresponding to a respective application in the list of selected applications, sending, to the second computer system, data corresponding to the respective application; and in accordance with a determination that the communication includes a confirmation that the first list of version identifiers matched a second list of version identifiers of the second computer system, forgoing sending, to the second computer system, the data.

In some examples, a method that is performed at a first computer system is described. In some examples, the method comprises: while the first computer system is configured to display a user-interface view with first configuration data, detecting a connection to a second computer system different from the first computer system; and after detecting the connection to the second computer system: in accordance with a determination that a first set of one or more criteria is met, causing, the second computer system, to display the user-interface view with second configuration data different from the first configuration data, wherein the second configuration data is corresponds to the second computer system; and in accordance with a determination that the first set of one or more criteria is not met, forgoing causing, the second computer system, to display the user-interface view with the second configuration data.

In some examples, a non-transitory computer-readable storage medium storing one or more programs configured to be executed by one or more processors of a first computer system is described. In some examples, the one or more programs includes instructions for: while the first computer system is configured to display a user-interface view with first configuration data, detecting a connection to a second computer system different from the first computer system; and after detecting the connection to the second computer system: in accordance with a determination that a first set of one or more criteria is met, causing, the second computer system, to display the user-interface view with second configuration data different from the first configuration data, wherein the second configuration data is corresponds to the second computer system; and in accordance with a determination that the first set of one or more criteria is not met, forgoing causing, the second computer system, to display the user-interface view with the second configuration data.

In some examples, a transitory computer-readable storage medium storing one or more programs configured to be executed by one or more processors of a first computer system is described. In some examples, the one or more programs includes instructions for: while the first computer system is configured to display a user-interface view with first configuration data, detecting a connection to a second computer system different from the first computer system; and after detecting the connection to the second computer system: in accordance with a determination that a first set of one or more criteria is met, causing, the second computer system, to display the user-interface view with second configuration data different from the first configuration data, wherein the second configuration data is corresponds to the second computer system; and in accordance with a determination that the first set of one or more criteria is not met, forgoing causing, the second computer system, to display the user-interface view with the second configuration data.

In some examples, a first computer system is described. In some examples, the first computer system comprises one or more processors and memory storing one or more program configured to be executed by the one or more processors. In some examples, the one or more programs includes instructions for: while the first computer system is configured to display a user-interface view with first configuration data, detecting a connection to a second computer system different from the first computer system; and after detecting the connection to the second computer system: in accordance with a determination that a first set of one or more criteria is met, causing, the second computer system, to display the user-interface view with second configuration data different from the first configuration data, wherein the second configuration data is corresponds to the second computer system; and in accordance with a determination that the first set of one or more criteria is not met, forgoing causing, the second computer system, to display the user-interface view with the second configuration data.

In some examples, a first computer system is described. In some examples, the first computer system comprises means for performing each of the following steps: while the first computer system is configured to display a user-interface view with first configuration data, detecting a connection to a second computer system different from the first computer system; and after detecting the connection to the second computer system: in accordance with a determination that a first set of one or more criteria is met, causing, the second computer system, to display the user-interface view with second configuration data different from the first configuration data, wherein the second configuration data is corresponds to the second computer system; and in accordance with a determination that the first set of one or more criteria is not met, forgoing causing, the second computer system, to display the user-interface view with the second configuration data.

In some examples, a computer program product is described. In some examples, the computer program product comprises one or more programs configured to be executed by one or more processors of a first computer system. In some examples, the one or more programs include instructions for: while the first computer system is configured to display a user-interface view with first configuration data, detecting a connection to a second computer system different from the first computer system; and after detecting the connection to the second computer system: in accordance with a determination that a first set of one or more criteria is met, causing, the second computer system, to display the user-interface view with second configuration data different from the first configuration data, wherein the second configuration data is corresponds to the second computer system; and in accordance with a determination that the first set of one or more criteria is not met, forgoing causing, the second computer system, to display the user-interface view with the second configuration data.

In some examples, a method that is performed at a first computer system is described. In some examples, the method comprises: establishing a relationship with a second computer system different from the first computer system; in conjunction with establishing the relationship with the second computer system, sending, to the second computer system, an archive corresponding to an application installed on the first computer system; and after sending the archive: in accordance with a determination that a first set of one or more criteria is met, wherein the first set of one or more criteria includes a criterion that is met when a first of amount of time has passed since the first computer system has last communicated with the second computer system, updating the archive at a first rate; and in accordance with a determination that a second set of one or more criteria is met different from the first set of one or more criteria, wherein the second set of one or more criteria includes a criterion that is met when a second of amount of time, different from the first amount of time, has passed since the first computer system has last communicated with the second computer system, deleting a portion of the archive.

In some examples, a non-transitory computer-readable storage medium storing one or more programs configured to be executed by one or more processors of a first computer system is described. In some examples, the one or more programs includes instructions for: establishing a relationship with a second computer system different from the first computer system; in conjunction with establishing the relationship with the second computer system, sending, to the second computer system, an archive corresponding to an application installed on the first computer system; and after sending the archive: in accordance with a determination that a first set of one or more criteria is met, wherein the first set of one or more criteria includes a criterion that is met when a first of amount of time has passed since the first computer system has last communicated with the second computer system, updating the archive at a first rate; and in accordance with a determination that a second set of one or more criteria is met different from the first set of one or more criteria, wherein the second set of one or more criteria includes a criterion that is met when a second of amount of time, different from the first amount of time, has passed since the first computer system has last communicated with the second computer system, deleting a portion of the archive.

In some examples, a transitory computer-readable storage medium storing one or more programs configured to be executed by one or more processors of a first computer system is described. In some examples, the one or more programs includes instructions for: establishing a relationship with a second computer system different from the first computer system; in conjunction with establishing the relationship with the second computer system, sending, to the second computer system, an archive corresponding to an application installed on the first computer system; and after sending the archive: in accordance with a determination that a first set of one or more criteria is met, wherein the first set of one or more criteria includes a criterion that is met when a first of amount of time has passed since the first computer system has last communicated with the second computer system, updating the archive at a first rate; and in accordance with a determination that a second set of one or more criteria is met different from the first set of one or more criteria, wherein the second set of one or more criteria includes a criterion that is met when a second of amount of time, different from the first amount of time, has passed since the first computer system has last communicated with the second computer system, deleting a portion of the archive.

In some examples, a first computer system is described. In some examples, the first computer system comprises one or more processors and memory storing one or more program configured to be executed by the one or more processors. In some examples, the one or more programs includes instructions for: establishing a relationship with a second computer system different from the first computer system; in conjunction with establishing the relationship with the second computer system, sending, to the second computer system, an archive corresponding to an application installed on the first computer system; and after sending the archive: in accordance with a determination that a first set of one or more criteria is met, wherein the first set of one or more criteria includes a criterion that is met when a first of amount of time has passed since the first computer system has last communicated with the second computer system, updating the archive at a first rate; and in accordance with a determination that a second set of one or more criteria is met different from the first set of one or more criteria, wherein the second set of one or more criteria includes a criterion that is met when a second of amount of time, different from the first amount of time, has passed since the first computer system has last communicated with the second computer system, deleting a portion of the archive.

In some examples, a first computer system is described. In some examples, the first computer system comprises means for performing each of the following steps: establishing a relationship with a second computer system different from the first computer system; in conjunction with establishing the relationship with the second computer system, sending, to the second computer system, an archive corresponding to an application installed on the first computer system; and after sending the archive: in accordance with a determination that a first set of one or more criteria is met, wherein the first set of one or more criteria includes a criterion that is met when a first of amount of time has passed since the first computer system has last communicated with the second computer system, updating the archive at a first rate; and in accordance with a determination that a second set of one or more criteria is met different from the first set of one or more criteria, wherein the second set of one or more criteria includes a criterion that is met when a second of amount of time, different from the first amount of time, has passed since the first computer system has last communicated with the second computer system, deleting a portion of the archive.

In some examples, a computer program product is described. In some examples, the computer program product comprises one or more programs configured to be executed by one or more processors of a first computer system. In some examples, the one or more programs include instructions for: establishing a relationship with a second computer system different from the first computer system; in conjunction with establishing the relationship with the second computer system, sending, to the second computer system, an archive corresponding to an application installed on the first computer system; and after sending the archive: in accordance with a determination that a first set of one or more criteria is met, wherein the first set of one or more criteria includes a criterion that is met when a first of amount of time has passed since the first computer system has last communicated with the second computer system, updating the archive at a first rate; and in accordance with a determination that a second set of one or more criteria is met different from the first set of one or more criteria, wherein the second set of one or more criteria includes a criterion that is met when a second of amount of time, different from the first amount of time, has passed since the first computer system has last communicated with the second computer system, deleting a portion of the archive.

In some examples, a method that is performed at a first computer system is described. In some examples, the method comprises: detecting a respective state of a second computer system different from the first computer system; in response to detecting the respective state of the second computer system: in accordance with a determination that a first set of one or more criteria is satisfied, updating content; and in accordance with a determination that a second set of one or more criteria, different from the first set of one or more criteria, is satisfied, forgoing update of the content; and after updating the content, sending, to the second computer system, the updated content for display by the second computer system.

In some examples, a non-transitory computer-readable storage medium storing one or more programs configured to be executed by one or more processors of a first computer system is described. In some examples, the one or more programs includes instructions for: detecting a respective state of a second computer system different from the first computer system; in response to detecting the respective state of the second computer system: in accordance with a determination that a first set of one or more criteria is satisfied, updating content; and in accordance with a determination that a second set of one or more criteria, different from the first set of one or more criteria, is satisfied, forgoing update of the content; and after updating the content, sending, to the second computer system, the updated content for display by the second computer system.

In some examples, a transitory computer-readable storage medium storing one or more programs configured to be executed by one or more processors of a first computer system is described. In some examples, the one or more programs includes instructions for: detecting a respective state of a second computer system different from the first computer system; in response to detecting the respective state of the second computer system: in accordance with a determination that a first set of one or more criteria is satisfied, updating content; and in accordance with a determination that a second set of one or more criteria, different from the first set of one or more criteria, is satisfied, forgoing update of the content; and after updating the content, sending, to the second computer system, the updated content for display by the second computer system.

In some examples, a first computer system is described. In some examples, the first computer system comprises one or more processors and memory storing one or more programs configured to be executed by the one or more processors. In some examples, the one or more programs includes instructions for: detecting a respective state of a second computer system different from the first computer system; in response to detecting the respective state of the second computer system: in accordance with a determination that a first set of one or more criteria is satisfied, updating content; and in accordance with a determination that a second set of one or more criteria, different from the first set of one or more criteria, is satisfied, forgoing update of the content; and after updating the content, sending, to the second computer system, the updated content for display by the second computer system.

In some examples, a first computer system is described. In some examples, the first computer system comprises means for performing each of the following steps: detecting a respective state of a second computer system different from the first computer system; in response to detecting the respective state of the second computer system: in accordance with a determination that a first set of one or more criteria is satisfied, updating content; and in accordance with a determination that a second set of one or more criteria, different from the first set of one or more criteria, is satisfied, forgoing update of the content; and after updating the content, sending, to the second computer system, the updated content for display by the second computer system.

In some examples, a computer program product is described. In some examples, the computer program product comprises one or more programs configured to be executed by one or more processors of a first computer system. In some examples, the one or more programs include instructions for: detecting a respective state of a second computer system different from the first computer system; in response to detecting the respective state of the second computer system: in accordance with a determination that a first set of one or more criteria is satisfied, updating content; and in accordance with a determination that a second set of one or more criteria, different from the first set of one or more criteria, is satisfied, forgoing update of the content; and after updating the content, sending, to the second computer system, the updated content for display by the second computer system.

In some examples, a method that is performed at a first computer system in communication with a display generation component and an input component is described. In some examples, the method comprises: while displaying, via the display generation component, a first user interface including a plurality of representations corresponding to different applications, detecting, via the input component, initiation of an input, wherein the plurality of representations includes a first representation corresponding to a first application and a second representation corresponding to a second application different from the first application; and in response to detecting the initiation of the input and while continuing to detect the input: in accordance with a determination that the input corresponds to the first representation, updating, via a second computer system in communication with the first computer system, content corresponding to the first application, wherein the second computer system is different from the first computer system; and in accordance with a determination that the input corresponds to the second representation, updating, via the second computer system, content corresponding to the second application.

In some examples, a non-transitory computer-readable storage medium storing one or more programs configured to be executed by one or more processors of a first computer system in communication with a display generation component and an input component is described. In some examples, the one or more programs includes instructions for: while displaying, via the display generation component, a first user interface including a plurality of representations corresponding to different applications, detecting, via the input component, initiation of an input, wherein the plurality of representations includes a first representation corresponding to a first application and a second representation corresponding to a second application different from the first application; and in response to detecting the initiation of the input and while continuing to detect the input: in accordance with a determination that the input corresponds to the first representation, updating, via a second computer system in communication with the first computer system, content corresponding to the first application, wherein the second computer system is different from the first computer system; and in accordance with a determination that the input corresponds to the second representation, updating, via the second computer system, content corresponding to the second application.

In some examples, a transitory computer-readable storage medium storing one or more programs configured to be executed by one or more processors of a first computer system in communication with a display generation component and an input component is described. In some examples, the one or more programs includes instructions for: while displaying, via the display generation component, a first user interface including a plurality of representations corresponding to different applications, detecting, via the input component, initiation of an input, wherein the plurality of representations includes a first representation corresponding to a first application and a second representation corresponding to a second application different from the first application; and in response to detecting the initiation of the input and while continuing to detect the input: in accordance with a determination that the input corresponds to the first representation, updating, via a second computer system in communication with the first computer system, content corresponding to the first application, wherein the second computer system is different from the first computer system; and in accordance with a determination that the input corresponds to the second representation, updating, via the second computer system, content corresponding to the second application.

In some examples, a first computer system in communication with a display generation component and an input component is described. In some examples, the first computer system in communication with a display generation component and an input component comprises one or more processors and memory storing one or more programs configured to be executed by the one or more processors. In some examples, the one or more programs includes instructions for: while displaying, via the display generation component, a first user interface including a plurality of representations corresponding to different applications, detecting, via the input component, initiation of an input, wherein the plurality of representations includes a first representation corresponding to a first application and a second representation corresponding to a second application different from the first application; and in response to detecting the initiation of the input and while continuing to detect the input: in accordance with a determination that the input corresponds to the first representation, updating, via a second computer system in communication with the first computer system, content corresponding to the first application, wherein the second computer system is different from the first computer system; and in accordance with a determination that the input corresponds to the second representation, updating, via the second computer system, content corresponding to the second application.

In some examples, a first computer system in communication with a display generation component and an input component is described. In some examples, the first computer system in communication with a display generation component and an input component comprises means for performing each of the following steps: while displaying, via the display generation component, a first user interface including a plurality of representations corresponding to different applications, detecting, via the input component, initiation of an input, wherein the plurality of representations includes a first representation corresponding to a first application and a second representation corresponding to a second application different from the first application; and in response to detecting the initiation of the input and while continuing to detect the input: in accordance with a determination that the input corresponds to the first representation, updating, via a second computer system in communication with the first computer system, content corresponding to the first application, wherein the second computer system is different from the first computer system; and in accordance with a determination that the input corresponds to the second representation, updating, via the second computer system, content corresponding to the second application.

In some examples, a computer program product is described. In some examples, the computer program product comprises one or more programs configured to be executed by one or more processors of a first computer system in communication with a display generation component and an input component. In some examples, the one or more programs include instructions for: while displaying, via the display generation component, a first user interface including a plurality of representations corresponding to different applications, detecting, via the input component, initiation of an input, wherein the plurality of representations includes a first representation corresponding to a first application and a second representation corresponding to a second application different from the first application; and in response to detecting the initiation of the input and while continuing to detect the input: in accordance with a determination that the input corresponds to the first representation, updating, via a second computer system in communication with the first computer system, content corresponding to the first application, wherein the second computer system is different from the first computer system; and in accordance with a determination that the input corresponds to the second representation, updating, via the second computer system, content corresponding to the second application.

In some examples, a method that is performed at a first computer system is described. In some examples, the method comprises: receiving a message including an identification of a second computer system different from the first computer system; and after receiving the message including the identification of the second computer system: in accordance with a determination that the first computer system is not paired with another computer system, automatically pairing with the second computer system without detecting a user input corresponding to a request to pair with the second computer system; and; in accordance with a determination that the first computer system is paired with another computer system, forgoing automatically pairing with the second computer system.

In some examples, a non-transitory computer-readable storage medium storing one or more programs configured to be executed by one or more processors of a first computer system is described. In some examples, the one or more programs includes instructions for: receiving a message including an identification of a second computer system different from the first computer system; and after receiving the message including the identification of the second computer system: in accordance with a determination that the first computer system is not paired with another computer system, automatically pairing with the second computer system without detecting a user input corresponding to a request to pair with the second computer system; and; in accordance with a determination that the first computer system is paired with another computer system, forgoing automatically pairing with the second computer system.

In some examples, a transitory computer-readable storage medium storing one or more programs configured to be executed by one or more processors of a first computer system is described. In some examples, the one or more programs includes instructions for: receiving a message including an identification of a second computer system different from the first computer system; and after receiving the message including the identification of the second computer system: in accordance with a determination that the first computer system is not paired with another computer system, automatically pairing with the second computer system without detecting a user input corresponding to a request to pair with the second computer system; and; in accordance with a determination that the first computer system is paired with another computer system, forgoing automatically pairing with the second computer system.

In some examples, a first computer system is described. In some examples, the first computer system comprises one or more processors and memory storing one or more programs configured to be executed by the one or more processors. In some examples, the one or more programs includes instructions for: receiving a message including an identification of a second computer system different from the first computer system; and after receiving the message including the identification of the second computer system: in accordance with a determination that the first computer system is not paired with another computer system, automatically pairing with the second computer system without detecting a user input corresponding to a request to pair with the second computer system; and; in accordance with a determination that the first computer system is paired with another computer system, forgoing automatically pairing with the second computer system.

In some examples, a first computer system is described. In some examples, the first computer system comprises means for performing each of the following steps: receiving a message including an identification of a second computer system different from the first computer system; and after receiving the message including the identification of the second computer system: in accordance with a determination that the first computer system is not paired with another computer system, automatically pairing with the second computer system without detecting a user input corresponding to a request to pair with the second computer system; and; in accordance with a determination that the first computer system is paired with another computer system, forgoing automatically pairing with the second computer system.

In some examples, a computer program product is described. In some examples, the computer program product comprises one or more programs configured to be executed by one or more processors of a first computer system. In some examples, the one or more programs include instructions for: receiving a message including an identification of a second computer system different from the first computer system; and after receiving the message including the identification of the second computer system: in accordance with a determination that the first computer system is not paired with another computer system, automatically pairing with the second computer system without detecting a user input corresponding to a request to pair with the second computer system; and; in accordance with a determination that the first computer system is paired with another computer system, forgoing automatically pairing with the second computer system.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a compute system in accordance with some examples.

FIG. 2 is a block diagram illustrating a device with interconnected subsystems in accordance with some examples.

FIG. 3 is a block diagram illustrating a source device communicating with multiple remote devices in accordance with some examples.

FIG. 4 is a flow diagram illustrating a process for a source device to provide a user-interface view to be displayed on a remote device in accordance with some examples.

FIG. 5 is a flow diagram illustrating a process to synchronize data between a source device and a remote device in accordance with some examples.

FIG. 6 is a flow diagram illustrating a process to remove data from a source device and a remote device in accordance with some examples.

FIG. 7 is a flow diagram illustrating a method for synchronizing data in accordance with some examples.

FIG. 8 is a flow diagram illustrating a method for configuring a user-interface view for a particular computer system in accordance with some examples.

FIG. 9 is a flow diagram illustrating a method for removal of an archive in accordance with some examples.

FIG. 10 is a flow diagram illustrating a process for a device to update content for another device in accordance with some examples.

FIG. 11 is a flow diagram illustrating a method for a device to update content for another device in accordance with some examples.

FIGS. 12A-12D illustrate exemplary user interfaces for updating content on a remote device in accordance with some examples.

FIG. 13 is a flow diagram illustrating a method for updating content on a remote device in accordance with some examples.

FIG. 14 illustrates exemplary user interfaces for a source device to automatically pair with a nearby device in accordance with some examples.

FIG. 15 is a flow diagram illustrating a method for a source device to automatically pair with a nearby device in accordance with some examples.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

Methods described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some examples, these terms are used to distinguish one element from another. For example, a first subsystem could be termed a second subsystem, and, similarly, a subsystem device could be termed a subsystem device, without departing from the scope of the various described embodiments. In some examples, the first subsystem and the second subsystem are two separate references to the same subsystem. In some examples, the first subsystem and the second subsystem are both subsystems, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

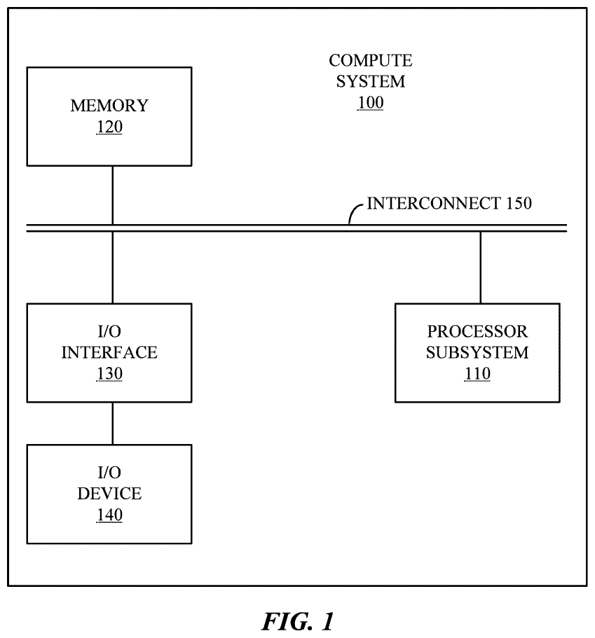

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some examples, I/O interface 130 is included with I/O device 140 such that the two are a single component. It should be recognized that there can be one or more I/O interfaces, with each I/O interface communicating with one or more I/O devices. In some examples, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some examples, compute system 100 is included or communicating with a physical component for the purpose of modifying the physical component in response to an instruction. In some examples, compute system 100 receives an instruction to modify a physical component and, in response to the instruction, causes the physical component to be modified. In some examples, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some examples, a sensor includes one or more hardware components that detect information about a physical environment in proximity to (e.g., surrounding) the sensor. In some examples, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some examples, a sensor includes a combination of multiple sensors. In some examples, sensor data is captured by fusing data from one sensor with data from one or more other sensors. Although a single compute system is shown in FIG. 1, compute system 100 can also be implemented as two or more compute systems operating together.

In some examples, processor subsystem 110 includes one or more processors or processing units configured to execute program instructions to perform functionality described herein. For example, processor subsystem 110 can execute an operating system, a middleware system, one or more applications, or any combination thereof.

In some examples, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive executive (AIX), network operating systems (e.g., Microsoft Windows Server), and real-time operating systems (e.g., QNX). In some examples, the operating system includes various procedures, sets of instructions, software components, and/or drivers for controlling and managing general system tasks (e.g., memory management, storage device control, power management, or the like) and for facilitating communication between various hardware and software components. In some examples, the operating system uses a priority-based scheduler that assigns a priority to different tasks that processor subsystem 110 can execute. In such examples, the priority assigned to a task is used to identify a next task to execute. In some examples, the priority-based scheduler identifies a next task to execute when a previous task finishes executing. In some examples, the highest priority task runs to completion unless another higher priority task is made ready.

In some examples, the middleware system provides one or more services and/or capabilities to applications (e.g., the one or more applications running on processor subsystem 110) outside of what the operating system offers (e.g., data management, application services, messaging, authentication, API management, or the like). In some examples, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some examples, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some examples, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some examples, the first node notifies the second node that the data has been stored in the memory by sending a pointer (e.g., a memory pointer, such as an identification of a memory location) to the second node so that the second node can access the data from where the first node stored the data. In some examples, the first node would send the data directly to the second node so that the second node would not need to access a memory based on data received from the first node.

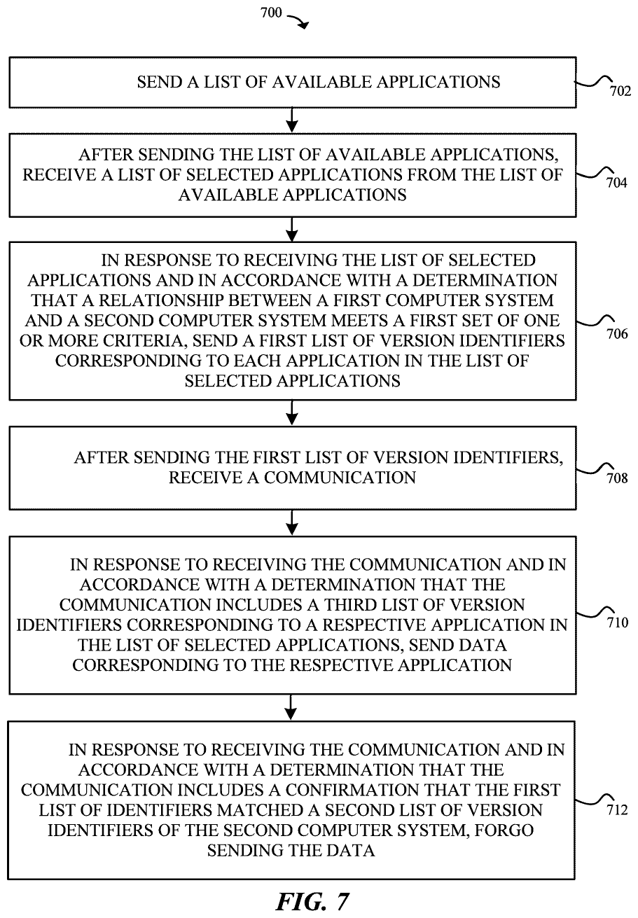

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with methods 700, 800, 900, 1100, 1300, and 1500 (FIGS. 7, 8, 9, 11, 13, and 15) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some examples, these other forms of storage can also store program instructions executable by processor subsystem 110 to perform operations described herein. In some examples, processor subsystem 110 (or each processor within processor subsystem 110) contains a cache or other form of on-board memory.

I/O interface 130 can be any of various types of interfaces configured to communicate with other devices. In some examples, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some examples, compute system 100 is communicating with a network via a network interface device (e.g., configured to communicate over Wi-Fi, Bluetooth, Ethernet, or the like). In some examples, compute system 100 is directly or wired to the network.

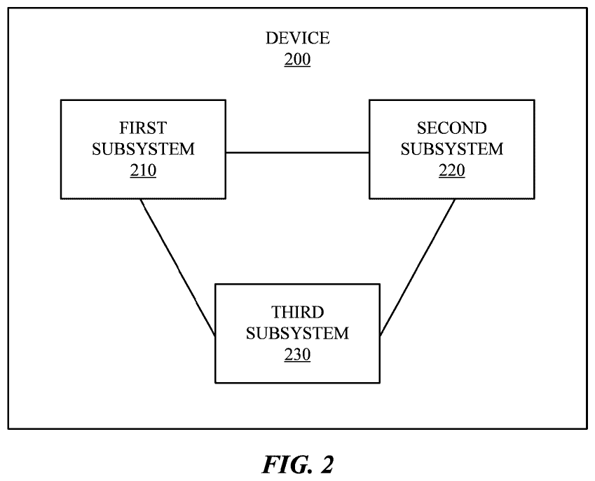

FIG. 2 illustrates a block diagram of device 200 with interconnected subsystems in accordance with some examples. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1 (i.e., compute system 100). Although three subsystems are shown in FIG. 2, device 200 can include more or fewer subsystems.

In some examples, some subsystems are not connected to other subsystem (e.g., first subsystem 210 can be connected to second subsystem 220 and third subsystem 230 but second subsystem 220 cannot be connected to third subsystem 230). In some examples, some subsystems are connected via one or more wires while other subsystems are wirelessly connected. In some examples, messages are set between the first subsystem 210, second subsystem 220, and third subsystem 230, such that when a respective subsystem sends a message the other subsystems receive the message (e.g., via a wire and/or a bus). In some examples, one or more subsystems are wirelessly connected to one or more compute systems outside of device 200, such as a server system. In such examples, the subsystem can be configured to communicate wirelessly to the one or more compute systems outside of device 200.

In some examples, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some examples, device 200 is configured to navigate (with or without user input) in a physical environment.

In some examples, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some examples, at least a portion of device 200 functions as a distributed compute system. For example, a task can be split into different portions, where a first portion is executed by first subsystem 210 and a second portion is executed by second subsystem 220.

Attention is now directed towards techniques for managing user-interface (UI) views (e.g., content being displayed) on different devices. Such techniques are described in the context of a source device communicating with a remote device. It should be recognized that different types of electronic devices can be used with techniques described herein. For example, a server can communicate with a remote device to display content by the remote device using techniques described herein. In addition, techniques optionally complement or replace other techniques for managing UI views on different devices.

As used herein, a UI view is a user interface that is rendered to be displayed. It should be understood that a UI view is different from a stream of what is being displayed on a device and/or application telemetry. In some examples, a UI view is not displayed on multiple devices but rather rendered by one device to be displayed on that device or another device. In some examples, a UI view is only displayed by a single device.

Techniques described herein can be used with respect to a smart phone and/or smart watch packaging and sending its data to a communal device (e.g., a shared device, such as a smart speaker, a television, a display in a vehicle, a tablet, a laptop, and/or a desktop) to be displayed at a later time. Such techniques allow a single application to be deployed on different devices without each device necessarily needing to execute the application. For example, a widget can be defined on a smart phone, and UI views for the widget can be sent to a communal device such that the UI views are displayed (e.g., concurrently and/or at different times with or without an active connection) by the smart phone and the communal device. In such an example, the smart phone can render a UI view of the widget and send the UI view to the communal device for display at a predefined and/or predetermined time. Examples of such widgets can include a calendar (e.g., a work calendar on the smart phone and a home calendar on the communal device), a current weather forecast (e.g., weather for different locations depending on which device is displaying the current weather forecast), and/or an accessory control (e.g., displaying a state of a light using the smart phone and the temperature of a heater using the communal device).

In some examples, interactions with the UI view on the communal device causes communications to be sent to the smart phone to determine how to respond. In other examples, interactions with the UI view on the communal device causes communications to be sent to a device other than the smart phone, such as a light when instructing the light to turn on.

In some examples, data for a widget sent from the smart phone to the communal device is sufficient enough to display a UI view of the widget without the communal device needing to have the widget installed and/or knowledge of the widget before receiving the data. Such data can also allow the communal device to display the UI view when the smart phone is not available because the data is sufficient for display. In some examples, a connection between the smart phone and the communal device is only needed (e.g., used and/or activated) when content (e.g., a UI view and/or a portion of a UI view) is generated and/or updated. In some examples, UI views of the widget can disappear when the smart phone stops communicating with and/or reaches (and/or exceeds) a predefined distance away from the communal device.

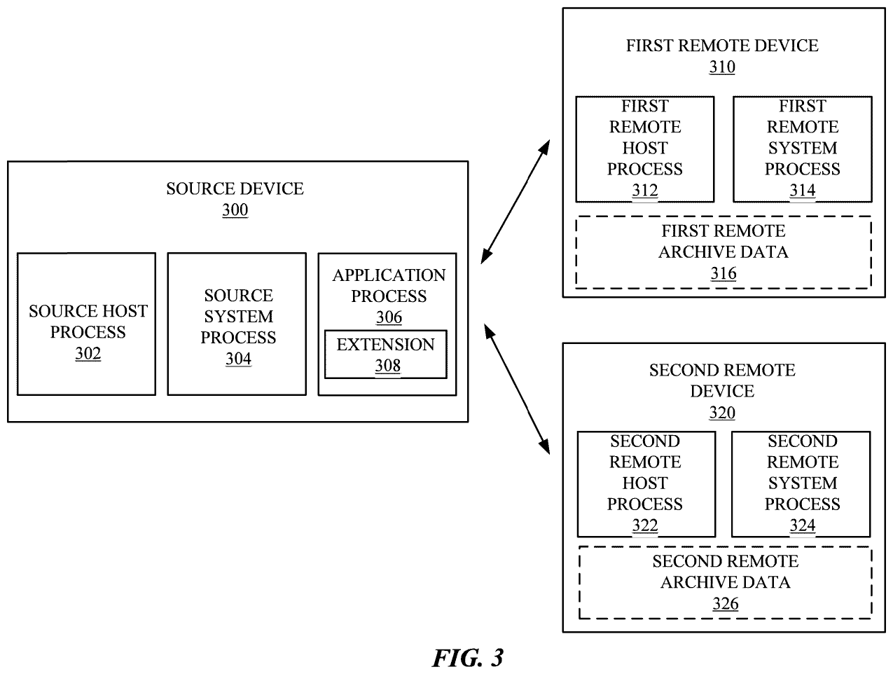

FIG. 3 is a block diagram illustrating a source device (e.g., source device 300) communicating with multiple remote devices (e.g., first remote device 310 and second remote device 320) in accordance with some examples. As used herein, a source device acts as a source of data for one or more remote devices and a remote device presents data from one or more source devices. It should be recognized that, in some examples, source device 300 communicates with a single remote device (e.g., first remote device 310 or second remote device 320) at a time instead of multiple remote devices. It should also be recognized that, in some examples, a remote device (e.g., first remote device 310 and/or second remote device 320) is restricted to communicating with a single source device at a time. In some examples, a remote device communicates with multiple source devices at a time and is able to concurrently display data corresponding to the multiple source devices.

In some examples, source device 300 is paired with first remote device 310 and/or second remote device 320, such as through one or more of the following: (A) an automatic process performed based on source device 300, first remote device 310, and/or second remote device 310 being logged into the same account or (B) a manual process performed by (1) source device 300 and/or (2) one of first remote device 310 or second remote device 320. In some examples, source device 300 communicates with first remote device 310 and/or second remote device 310 via a network (e.g., a wired or wireless network), such as a local network (e.g., a short-range network) including a direct link, Wi-Fi, and/or Bluetooth. In some examples, source device 300 is not communicating with first remote device 310 and/or second remote device 310 via a long-range network, such as the Internet.

In some examples, source device 300, first remote device 310, and/or second remote device 310 include one or more features described above with respect to compute system 100 and/or device 200. For example, source device 300 can be a personal device of a user, such as a smart phone or smart watch and first remote device 310 and/or second remote device 320 can be a communal device (e.g., a shared device corresponding to zero or more users, such as the user of source device 300 and/or a different user), such as a laptop, desktop, tablet, television, and/or other type of computer system.

As illustrated in FIG. 3, source device 300 includes source host process 302, source system process 304, and application process 306. It should be recognized that different processes of source device 300 can communicate with each other (e.g., source host process 302 with source system process 304 and/or source system process 304 with application process 306 and/or extension 308). It should also be recognized that more or fewer processes can be included in source device 300.

In some examples, source host process 302 corresponds to a process executing on source device 300 that manages a user interface with content from one or more sources. For example, the user interface can be a lockscreen of source device 300 that includes user-interface views for one or more widgets corresponding to different applications executing on source device 300. For another example, the user interface can be a homescreen of source device 300 that includes user-interface (UI) views for one or more applications executing on source device 300 and one or more icons that, when selected, initiate and/or display applications executing on source device 400. In such examples, the UI views can be managed by an operating system of source device 300 and include content provided by the one or more applications. For another example, the user interface can be a user interface of an application executing on source device 300.

In some examples, source system process 304 corresponds to a process executing on source device 300 that manages communications between (1) source host process 302 and (2) application process 306, extension 308, first remote device 310, and/or second remote device 320. For example, source system process 304 can be a non-UI daemon of an operating system running on source device 300.

In some examples, application process 306 corresponds to an application executing on source device 300. While a single application process 306 is illustrated in FIG. 3, it should be recognized that source device 300 can include other application processes corresponding to other applications that are installed on source device 300. FIG. 3 illustrates that application process 306 includes extension 308. In some examples, extension 308 is a portion of application process 306 that is able to execute independently of application process 306. In some examples, extension 308 corresponds to specific functionality that is handled by extension 308. For example, extension 308 can correspond to one or more widgets provided by application process 306. Such widgets can prepare and/or render UI views to be displayed by (1) source host process 302 and/or (2) first remote device 310 and/or second remote device 320 via source system process 304, as further discussed below.

In some examples, source system process 304 maintains services for multiple different applications, each service corresponding to a different application. In some examples, each service can maintain a separate connection with a remote device to optimize data communication. In some examples, each separate connection uses the same endpoint on source device 300 and/or a remote device to facilitate sharing between devices.

As illustrated in FIG. 3, each remote device (first remote device 310 and second remote device 320) includes a remote host process (e.g., first remote host process 312 and second remote host process 322) and a remote system process (e.g., first remote system process 314 and second remote system process 324). Such components can include at least a portion of functionality as described above for their corresponding components of source device 300. For example, first remote host process 312 can correspond to a process executing on remote device 310 that manages a user interface with content from one or more sources. For example, the user interface can be a notification center of remote device 310 that includes UI views for one or more widgets corresponding to different applications executing on source device 300 and/or first remote device 310.

As illustrated in FIG. 3, each remote device (first remote device 310 and second remote device 320) optionally includes remote archive data (e.g., first remote archive data 316 and second remote archive data 326). In some examples, the remote archive data includes operations, configurations, and/or data specific to one or more different applications (the term “applications” is used herein to refer to applications and/or extensions of applications, such as widgets) executing on another device (e.g., source device 300). For example, first remote archive data 316 can include an archive received from source device 300, the archive corresponding to extension 308. The archive can include UI views to be displayed by first remote device 310, logic and/or code configured to indicate when to display one or more of the UI views, snapshots and/or icons corresponding to the archive, and/or any other data needed by first remote device 310 to display a UI view rendered or facilitated by source device 300, as further discussed below. In some examples, the archive includes configuration data that is specific to first remote device 310, such as data indicating how to configure a UI view displayed by first remote device 310. For example, the configuration data can specify a location to be used by first remote device 310 when displaying a weather forecast provided by extension 308 of source device 300.

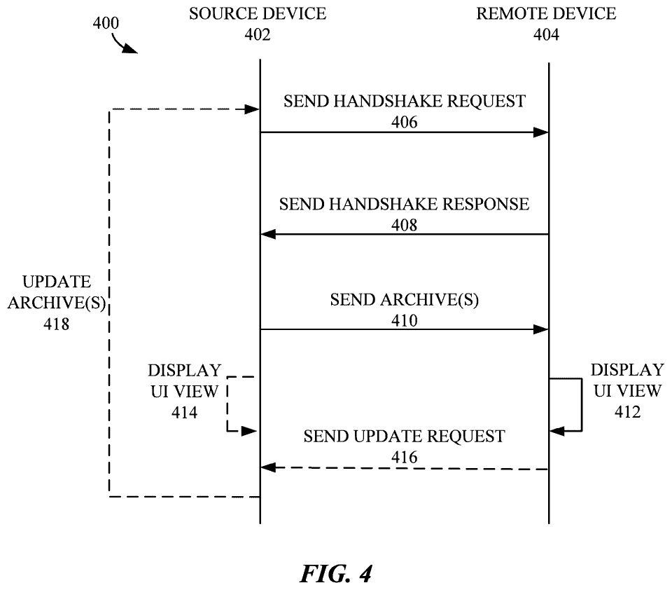

Using the configuration described above with respect to FIG. 3, a source device and a remote device can communicate data between each other, allowing the source device to provide content displayed by the remote device. In some examples, different configurations can be established for different remote devices such that different content is automatically displayed depending on which remote device is being used. The figures below, including FIGS. 4-9, describe techniques enabling such features.

FIG. 4 is a flow diagram illustrating a process (e.g., process 400) for a source device (e.g., source device 402) to provide a user-interface (UI) view to be displayed on a remote device (e.g., remote device 404) in accordance with some examples. It should be recognized that (1) source device 402 can correspond to source device 300 and (2) remote device 404 can correspond to first remote device 310 or second remote device 320.

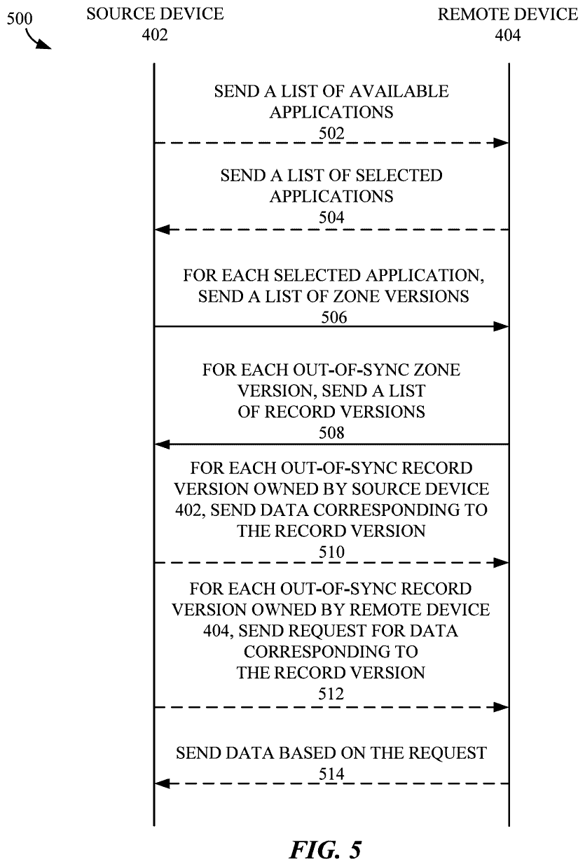

The operations at 406-410 correspond to a state replication protocol, as further described with respect to FIG. 5. In some examples, the state replication protocol can ensure that source device 402 and remote device 404 are synchronized with each other. Such synchronization can correspond to data that is owned by each device. For example, source device 402 can own (e.g., only edited by source device 402 but readable by remote device 404) a first set of data (e.g., descriptors (e.g., names, snapshots, and/or other metadata) and/or timelines (e.g., defined events for when to display different UI views and/or how to respond to different types of inputs) of different applications) and remote device 404 can own (e.g., only edited by remote device 404 but readable by source device 402) a second set of data (e.g., configurations specific to remote device 404 that changes how UI views appear) different from the first set of data, such different sets of data synchronized with the other device using the state replication protocol. This scheme can eliminate the need for conflict resolution before, during, and/or after synchronization. In some examples, the state replication protocol occurs each time a new communication session is initiated between source device 402 and remote device 404.

At 406, source device 402 sends a handshake request to remote device 404. In some examples, the handshake request includes session information (e.g., an identification (e.g., a unique identification, such as a UUID) of a current communication session between source device 402 and remote device 404) and/or device information corresponding to source device 402 (e.g., an identifier corresponding to source device 402, a user-assigned name of source device 402, a minimum supported protocol version, a current supported protocol version, and/or whether source device 402 is a possible source device for a remote device). Using the handshake request (e.g., the session information, the device information corresponding to source device 402, and/or other information included in the handshake request), remote device 404 can verify that source device 402 and remote device 404 are compatible with each other and are able to communicate.

In some examples, the handshake request includes an indication of available applications, as further discussed below with respect to FIG. 5. Such available applications can be installed on source device 402 and can support sharing UI views with remote device 404.

In some examples, the handshake request includes zone versions for data stored by source device 402 (e.g., data corresponding to the available applications described above). In some examples, zone versions include a hash of versions of records in zones of which source device 402 is aware. For example, such zones can correspond to the types of data described above (e.g., descriptors, timelines, icons, and/or configurations) and/or some different division of data. Each zone can include a number of records (e.g., one record for each descriptor, timeline, icon, and/or configuration), and each record can include a version (e.g., a UUID that changes when the records themselves change) (referred to as a “record version” herein). For example, a version of a zone (referred to as a “zone version” herein) can be represented by combining versions of each record in that zone into a single hash. In some examples, the indication of available applications described above includes the zone versions. In some examples, the zone versions are separate from the indication of available applications described above.

In some examples, remote device 404 determines a desired relationship between source device 402 and remote device 404 in response to receiving the handshake request. Examples of desired relationships can include introduced (e.g., the devices discovered each other but are not paired and have not exchanged data with respect to applications), pairing (e.g., one device is trying to pair with the other), paired (e.g., the devices are paired and can exchange data with respect to applications), and unpairing (e.g., one device no longer wants to be paired with the other). In some examples, the handshake request includes an indication of the desired relationship, the indication indicating a desired state (e.g., either the current state (such as when no change in relationship is desired) or a new state (such as when source device 402 wants to change the current state)).

At 408, remote device 404 sends a handshake response to source device 402. In some examples, the handshake response includes an indication of selected applications, as further discussed below with respect to FIG. 5. Such selected applications can be selected by remote device 404 from the available applications indicated by the handshake request. For example, remote device 404 can detect input corresponding to selection of the selected applications.

In some examples, the handshake response includes zone versions and/or record versions. In such examples, the zone versions can be a hash of versions of records in zones that remote device 402 is aware. In other examples, the zone versions can be individual zone versions for each zone version that does not match a zone version included in the handshake request. In some examples, the record versions include a record version for each record from a zone whose version on remote device 404 does not match a version received in the handshake request.

In some examples, the handshake response includes the session information included in the handshake request and/or device information corresponding to remote device 404. Using the handshake request (e.g., the session information, the device information corresponding to remote device 404, and/or other information included in the handshake response), source device 402 can verify that source device 402 and remote device 404 are compatible with each other.

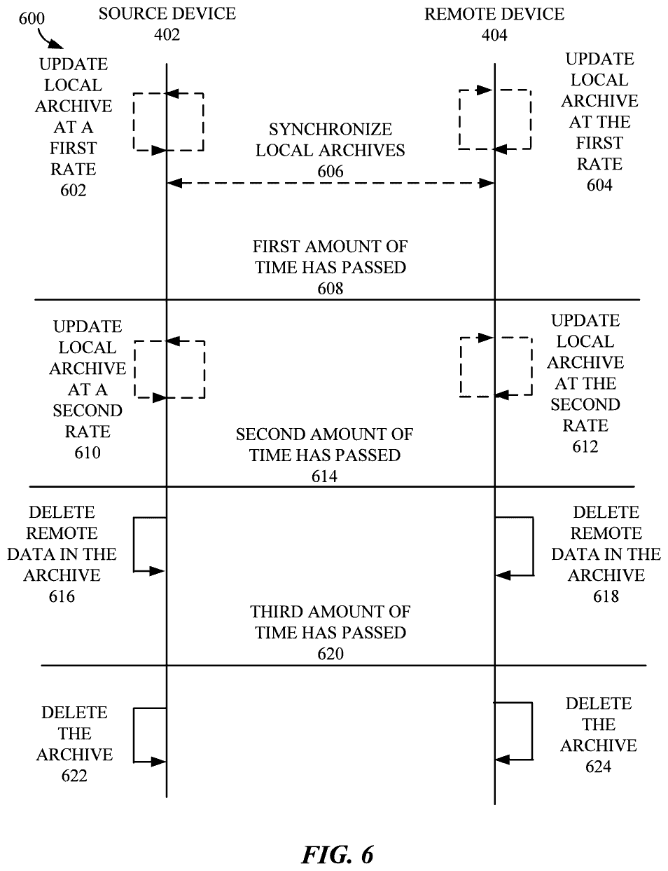

In some examples, source device 402 determines a desired relationship between source device 402 and remote device 404 in response to receiving the handshake response. The desired relationship can be the same as described above with respect to 406. In some examples, the handshake response includes an indication of the desired relationship, the indication indicating a desired state (e.g., either the current state (such as when no change in relationship is desired) or a new state (such as when remote device 404 wants to change the current state)). In some examples, source device 402 confirms compatibility and/or the desired relationship determined by remote device 404. In some examples, the handshake response includes an indication of a different relationship than included in the handshake request, such as when remote device 404 rejects the handshake request to change the relationship. In some examples, source device 402 and/or remote device 404 stores data about relationships between other devices. The data can include identification information for one or both devices, last incoming connection, last outgoing connection, a state of the relationship, and/or whether the relationship is suspended (e.g., relationships with devices that are not contacted for extended periods are suspended, as further discussed below with respect to FIG. 6).

In some examples, in response to receiving the handshake response, source device 402 sends a handshake complete message to remote device 404. The handshake complete message can indicate that a handshake between source device 402 and remote device 404 has been successful. In some examples, the handshake complete message includes the session information included in the handshake response, an indication of a relationship (e.g., as described above, including the same and/or different relationship indicated by the handshake response), and/or record versions representing records from a zone whose version on source device 402 does not match a version received in the handshake response. In some examples, the record versions included in the handshake complete message are those related to data owned by source device 402 and/or remote device 404. At this time, the handshake between source device 402 and remote device 404 is complete.

The rest of FIG. 4 covers a situation in which devices are pairing and/or paired but have not exchanged data with respect to the selected applications before. FIG. 5 covers a situation in which devices have already exchanged some data with respect to selected applications before.

At 410, source device 402 sends one or more archives to remote device 404. Such sending can occur in response to source device 402 receiving the handshake response at 408. In some examples, the one or more archives correspond to the selected applications. Such archives can each correspond to a different selected application and include data used by remote device 404 to display UI views. For example, the data can include rendered UI views, descriptors, timelines, and/or configurations (e.g., configurations specific to source device 402 and/or remote device 404), as described above. In some examples, the data of an archive includes a view template that has a declarative syntax for generating a UI view. The view template can include links to remote data sources, the links used by remote device 404 (e.g., first remote host process 310 and/or first remote system 314) to fetch data from the remote data sources when processing the template to render the UI view.

At 412, remote device 404 displays a first UI view corresponding to an archive received at 410. Such display can occur in response to remote device 404 receiving the one or more archives in 410. In some examples, the first UI view is displayed concurrently with data not corresponding to the archive received at 410 (and/or any archive received at 410). In such examples, the first UI view can be displayed with content rendered by remote device 404. In some examples, the first UI view is configured according to configuration data specific to remote device 404. Such configuration data can be different from configuration data used to display a corresponding UI view (e.g., a second UI view) by source device 402. In other words, the first UI view can include display of different data than the second UI view even though both UI views correspond to the same application. Such differences can be based on the configuration data specific to remote device 404, where the second UI view is configured according to configuration data specific to source device 402. An example of a UI view is an indication of weather in San Francisco. In such an example, the configuration data specific to remote device 404 can include an indication of San Francisco while configuration data specific to source device 402 can include an indication of San Mateo, causing the second UI view to include an indication of weather in San Mateo instead of San Francisco. For another example, the first UI view can include an event from a work calendar while the second UI view can include an event from a personal calendar, the difference caused by configuration data for each specifying which calendar to use.

At 414, source device 402 optionally displays the second UI view. Such display can occur in response to source device 402 detecting input by a user (e.g., unrelated to 406-410). In some examples, the second UI view is displayed while the first UI view is displayed. In such examples, both can be displayed when source device 402 and remote device 404 are in proximity to each other. Such concurrent display can be separate (e.g., remote device 404 causes first UI view to be displayed, source device 402 causes second UI view to be displayed), automatic (remote device 404 can be displayed based on proximity of remote device 404 to source device 402 and not based on user input detected by source device 402 and/or remote device 404 to request for display of the first UI view), and/or include different content in each (e.g., based on configuration data established on source device 402 for the second UI view and configuration data established on remote device 404 for the first UI view).

At 416, remote device 404 sends an update request to source device 402. Such sending can occur while remote device 404 is displaying the first UI view. In some examples, the update request is based on remote device 404 detecting input corresponding to the first UI view, such as a user interacting with the first UI view. In some examples, the update request is based on remote device 404 determining that it needs information from source device 402 to display content (e.g., in response to an event occurring and/or time passing). In some examples, the update request is periodically sent by remote device 404 to ensure that remote device 404 is up to date. In some examples, the update request includes an indication of a state of the first UI view and/or a state of remote device 404.

At 418, source device 402 updates one or more archives stored by source device 402. In some examples, the updates occur in response to source device 402 receiving the update request at 416. In such examples, the updates can be based on the update request. In other examples, source device 402 updates the one or more archives according to an event occurring unrelated to remote device 404. For example, source device 402 can update a stock ticker over time, such changes occurring unrelated to any request by remote device 404.

In some examples, in response to updating the one or more archives, source device 402 performs another iteration of one or more operations described above, including sending a handshake request at 406. In such examples, the other iteration of the one or more operations can be performed to ensure that the one or more archives are synchronized between source device 402 and remote device 404. In some examples, the other iteration of the one or more operations includes source device 402 sending an update of one or more archives to remote device 404, the update including at least a portion of an archive corresponding to the first UI view. For example, the portion can include an update to the first UI view and/or include a different UI view to be displayed by remote device 404. In such an example, the portion can be determined based on the update request and/or updates that source device 402 have made to the archive unrelated to the update request.

After receiving the update of one or more archives, remote device 404 can re-display the first UI view and/or display the different UI view. Such display can occur in response to receiving the update from source device 402. In some examples, re-displaying the first UI view includes updating at least a portion of the first UI view with updated information and/or content received from source device 402. In other examples, re-displaying the first UI view includes updating at least a portion of the first UI view with updated information and/or content defined by a timeline stored by remote device 404, the timeline optionally received before sending the update request at 416 (e.g., such as at 410).

FIG. 5 is a flow diagram illustrating a process (e.g., process 500) to synchronize data between a source device (e.g., source device 402) and a remote device (e.g., remote device 404) in accordance with some examples. In some examples, process 500 is an example of a state replication protocol as described above. For example, process 500 can occur after source device 402 is paired with and communicating with remote device 404.

At 502, source device 402 sends a list of available applications to remote device 404. As mentioned above, each application in the list of available applications can be installed on source device 402 and configured to be packaged and sent to remote device 404 for display of UI views corresponding to the application. The list of available applications can be included in a handshake request (e.g., 406) and/or after a handshake is completed. In some examples, each application in the list of available applications is identified by a unique identifier (e.g., a UUID), a name corresponding to the application, and/or a version of an archive (e.g., stored by source device 402) corresponding to the application.

At 504, remote device 404 sends a list of selected applications to source device 402. The list of selected applications can be sent in response to remote device 404 receiving the list of available applications and selecting (e.g., via user input) a subset of applications in the list of available applications. The list of available applications can be included in a handshake response (e.g., 408) and/or after a handshake is completed. In some examples, each application in the list of selected applications is identified by a unique identifier (e.g., a UUID), a name corresponding to the application, and/or a version of an archive (e.g., stored by remote device 404) corresponding to the application. In some examples, each application in the list of selected applications is identified by and/or sent with a hash of data corresponding to the application, such as data stored by remote device 404 to display one or more UI views corresponding to the application (sometimes referred to as an archive). In such examples, the data can be a list of zone versions (as described above), each zone version including a hash of data stored by remote device 404 and corresponding to a particular type of data (e.g., UI views, descriptors, icons, snapshots, timelines, and/or configurations). When zone versions are sent by remote device 404 as part of the list of selected applications, 506 is skipped and 508-514 are performed by the opposite device (e.g., for each out-of-sync zone version, source device 402 sends a list of record versions corresponding to the out-of-sync zone version to remote device 404; for each out-of-sync record version owned by remote device 404, remote device 404 sends data corresponding to the out-of-sync record version; for each out-of-sync record version owned by source device 402, remote device 404 sends a request for data corresponding to the out-of-sync record version; and source device 402 sends data based on the request).

At 506, for each selected application in the list of selected applications, source device 402 sends a list of zone versions (similar to as described above with respect to 504 except corresponding to and/or stored by source device 402 instead of remote device 404) corresponding to the selected application. The list of zone versions can be sent in response to receiving the list of selected applications. In some examples, instead of sending a different list of zone versions for each application, a zone version can be sent that corresponds to a type of data for multiple applications (e.g., all or less than all applications in the list of selected applications).

At 508, for each out-of-sync zone version, remote device 404 sends a list of record versions corresponding to the out-of-sync zone version. The list of record versions can be sent in response to receiving the list of zone versions. In some examples, instead of sending a different list of zone versions for each application, a zone version can be sent that corresponds to a type of data for multiple applications (e.g., all or less than all applications in the list of selected applications). In some examples, an out-of-sync zone version is when a representation (e.g., a hash) of a type of data stored by remote device 404 does not match and/or is missing from a zone version received from source device 402.

At 510, for each out-of-sync record version owned by source device 402, source device 402 sends data corresponding to the out-of-sync record version owned by source device 402. The data corresponding to the out-of-sync record version owned by source device 402 can be sent in response to receiving the list of record versions. In some examples, an out-of-sync record version is a representation (e.g., a hash) of data stored by remote device 404 that does not match, has been deleted, and/or is missing from a record version received from remote device 404.

At 512, for each out-of-sync record version owned by remote device 404, source device 402 sends a request for data corresponding to the out-of-sync record version owned by remote device 404. The request can be sent in response to receiving the list of record versions (before, during, or after sending the data corresponding to the out-of-sync record version owned by source device 402).

At 514, remote device 404 sends source device 402 data based on the request. The data can be sent in response to receiving the request. In some examples, the data corresponds to an out-of-sync record version owned by remote device 404.

FIG. 6 is a flow diagram illustrating a process (e.g., process 600) to remove data from a source device (e.g., source device 402) and a remote device (e.g., remote device 404) in accordance with some examples. In some examples, process 600 is an example of a device isolation and/or disconnection protocol. For example, process 600 can occur after source device 402 and/or remote device 404 has stored an archive corresponding to an application of source device 402, the archive used to display one or more UI views by remote device 404. Such a protocol can be useful when a source device interacts with many different remote devices in different amounts. The protocol can reduce time for updating and/or reduce space in memory for techniques described herein with remote devices that the source device has not communicated with recently and/or is unlikely to communicate with in the near future. For example, a personal device of a user can be used with devices in different conference rooms. The personal device and/or a device in a conference room can mitigate resource usage when connecting with several other devices by reducing an amount of updating and/or number of archives stored using techniques described below.

Process 600 is divided into four phases: a first phase of operations that occur before a first amount of time (e.g., 1-7 days) has passed (608), a second phase of operations that occur after the first amount of time has passed but before a second amount of time (e.g., 7-21 days) has passed (614), a third phase of operations that occur after the second amount of time has passed but before a third amount of time (e.g., 21-360 days) has passed (620), and a fourth phase of operations that occur after the third amount of time has passed. The amounts of time represent an amount of time that has lapsed during which source device 402 and remote device 404 have not communicated. In some examples, source device 402 and/or remote device 404 transition a state of the relationship between the two devices between different states from “paired” to “unpaired” as the time since the devices last communicated reaches or increases beyond a threshold amount of time. In some examples, one or more phases can require a different amount of time for source device 402 as compared to (e.g., a corresponding and/or similar phase of) remote device 404.

At 602, in the first phase (e.g., before the first amount of time has passed (608) (e.g., since a communication corresponding to 606)), source device 402 updates a local archive stored by source device 402 at a first rate (e.g., every hour, every 2 hours, and/or every time that source device 402 is at least a certain percentage (e.g., 0-50%) idle). Such update can occur locally on source device 402 and not with respect to remote device 404. In some examples, source device 402 continues to update the local archive during the first phase at the first rate.

At 604, in the first phase, remote device 404 updates a local archive stored by remote device 404 at the first rate (e.g., every hour, every 2 hours, and/or every time that remote device 404 is at least a certain percentage (e.g., 0-50%) idle). Such update can occur locally on remote device 404 and not with respect to source device 402. In some examples, remote device 404 continues to update the local archive during the first phase at the first rate. In some examples, the rate of update for remote device 404 is different from the rate of update for source device 402.

At 606, in the first phase, source device 402 and remote device 404 synchronize the local archives stored on each device (e.g., perform one or more operations described above, though there might not be any changes exchanged). As part of synchronizing, source device 402 and remote device 404 communicate and, in some examples, source device 402 and/or remote device 404 update a relationship with respect to the other to indicate when a last communication occurred.

At 610, in the second phase (e.g., after the first amount of time has passed but before a second amount of time has passed (614) (e.g., since a communication corresponding to 606)), source device 402 updates the local archive stored by source device 402 at a second rate (e.g., every day, every 2 days, and/or every time that source device 402 is at least a certain percentage (e.g., 0-10%) idle) (e.g., a slower rate than the first rate). Such update can occur locally on source device 402 and not with respect to remote device 404. In some examples, source device 402 continues to update the local archive during the second phase at the second rate. In some examples, source device 402 changes a state of the relationship with remote device 404 to suspended at 610.

At 612, in the second phase, remote device 404 updates the local archive stored by remote device 404 at the second rate (e.g., every day, every 2 days, and/or every time that remote device 404 is at least a certain percentage (e.g., 0-10%) idle) (e.g., a slower rate than the first rate). Such update can occur locally on remote device 404 and not with respect to source device 402. In some examples, remote device 404 continues to update the local archive during the second phase at the second rate. In some examples, the rate of update for remote device 404 is different from the rate of update for source device 402. In some examples, remote device 404 changes a state of the relationship with source device 402 to suspended at 612. In some examples, source device 402 and/or remote device 404 stops updating a respective local archive in the second phase.

At 616, in the third phase (e.g., after the second amount of time has passed but before a third amount of time has passed (614) (e.g., since a communication corresponding to 606)), source device 402 ceases to update the local archive stored by source device 402 and/or deletes a portion of the local archive corresponding to data owned by remote device 404 (referred to as remote data). Such deletion can occur locally on source device 402 and not with respect to remote device 404. In some examples, source device 402 continues to update the local archive with respect to data owned by source device 402 during the third phase (e.g., at the second rate or at a rate slower than the second rate).

At 618, in the third phase, remote device 404 ceases to update the local archive stored by remote device 404 and/or deletes a portion of the local archive corresponding to data owned by source device 402 (referred to as remote data). Such deletion can occur locally on remote device 404 and not with respect to source device 402. In some examples, remote device 404 continues to update the local archive with respect to data owned by remote device 404 during the third phase (e.g., at the second rate or at a rate slower than the second rate). After 616 and/or 618 and while in the third phase, source device 402 and/or remote device 404 can recover any data deleted by synchronizing with the other device according to techniques described above (e.g., 606). Such synchronizing can cause source device 402 and/or remote device 404 to go back to the first phase.

At 622, in the fourth phase (e.g., after the third amount of time has passed), source device 402 deletes (e.g., all or substantially all) the local archive stored on source device 402. Such deletion can occur locally on source device 402 and not with respect to remote device 404. In some examples, in addition to and/or instead of deleting the local archive in the fourth phase, source device 402 deletes data corresponding to remote device 404 (e.g., data about the relationship between source device 402 and remote device 404). In some examples, deleting the local archive and/or data corresponding to remote device 404 causes source device 402 and/or remote device 404 to re-establish a relationship when communicating with each other after, such as if they had not previously had a relationship. In some examples, remote device 404 can maintain the relationship for source device 402 and re-establish the relationship for source device 402 when communicating with source device 402. In some examples, in the fourth phase, source device 402 changes a state of the relationship with remote device 404 to unpaired.

At 624, in the fourth phase, remote device 404 deletes (e.g., all or substantially all) the local archive stored on remote device 404. Such deletion can occur locally on remote device 404 and not with respect to source device 402. In some examples, in addition to and/or instead of deleting the local archive in the fourth phase, remote device 404 deletes data corresponding to source device 402 (e.g., data about the relationship between source device 402 and remote device 404). In some examples, deleting the local archive and/or data corresponding to source device 402 causes source device 402 and/or remote device 404 to re-establish a relationship when communicating with each other after, such as if they had not previously had a relationship. In some examples, source device 402 can maintain the relationship for remote device 404 and re-establish the relationship for remote device 404 when communicating with remote device 404. In some examples, in the fourth phase, remote device 404 changes a state of the relationship with source device 402 to unpaired.

In some examples, techniques described herein are based on a clock maintained by a source device and/or a remote device. It should be recognized that some techniques prioritize clock times provided by the source device or the remote device (e.g., when the clock times are not the same, such techniques use a clock time provided by the prioritized device, such as the device providing the data or the device displaying the data). In some examples, techniques described herein are based on a location detected by a source device and/or a remote device. It should be recognized that some techniques prioritize a location detected by the source device or the remote device (e.g., when the locations are not the same, such techniques use a location detected by the prioritized device, such as the device providing the data or the device displaying the data). In some examples, techniques described herein include content in a particular language. It should be recognized that some techniques prioritize a language set by the source device or the remote device (e.g., when the languages are not the same, such techniques use a language set by the prioritized device, such as the device providing the data or the device displaying the data).

FIG. 7 is a flow diagram illustrating a method (e.g., method 700) for synchronizing data in accordance with some examples. Some operations in method 700 are, optionally, combined, the orders of some operations are, optionally, changed, and some operations are, optionally, omitted.

In some examples, method 700 is performed at a first computer system (e.g., a source computer system that acts as a source of data for a remote computer system (e.g., the second computer system)) (e.g., via a system process (e.g., an operating system process) that is different from one or more applications executing and/or installed on the first computer system). In some examples, the first computer system is a phone, a tablet, a laptop, a desktop computer, a fitness tracking device, a wearable device, an accessory device, a smart speaker, and/or a television.

At 702, the first computer system sends (e.g., via a short-range communication channel, such as WiFi, Bluetooth, and/or NFC), to a second computer system (e.g., a communal computer system and/or a remote computer system that presents data from the first computer system) different from the first computer system, a list (e.g., a group, a map, a data structure, a collection, and/or a set) of available (e.g., downloaded, installed, supported, executing, and/or recommended) applications (e.g., a list of identifiers of available applications) (e.g., a list of application extensions) (e.g., a list of user-interface views). In some examples, the second computer system is a phone, a tablet, a laptop, a desktop computer, a fitness tracking device, a wearable device, an accessory device, a smart speaker, and/or a television. In some examples, the list of available applications is with respect to the first computer system. In some examples, the list of available applications is with respect to the second computer system. In some examples, the second computer system is paired with the first computer system based on both being logged into the same account (e.g., with a remote storage system). In some examples, the list of available applications includes a plurality of applications. In some examples, the list of available applications is sent to a system process of the second computer system (e.g., a system process corresponding to the system process of the first computer system performing these steps). In some examples, before sending the list of available applications, the first computer system sends, to the second computer system, an identifier and/or a protocol version used by the first computer system. In some examples, the list is a sorted list, an ordered list, and/or an unordered list.

At 704, after (e.g., during a communication session and/or while waiting on a response to sending the list of available applications) sending the list of available applications, the first computer system receives (e.g., via the short-range communication channel), from the second computer system, a list (e.g., a group, a map, a data structure, a collection, and/or a set) of selected applications from the list of available applications (e.g., a list of identifiers of selected applications). In some examples, the list of selected applications is a subset of the list of available applications. In some examples, the list of selected applications is selected by the second computer system. In some examples, the list of selected applications is selected via input received by the second compute system. In some examples, the list of selected applications includes a plurality of applications. In some examples, the list is a sorted list, an ordered list, and/or an unordered list.

At 706, in response to receiving the list of selected applications and in accordance with a determination that a relationship between the first computer system and the second computer system meets a first set of one or more criteria, the first computer system sends (e.g., via the short-range communication channel and/or an intermediary device), to the second computer system, a first list (e.g., a group, a map, a data structure, a collection, and/or a set) of version identifiers (e.g., a plurality of version identifiers and/or one or more version identifiers) corresponding to each application in the list of selected applications. In some examples, in response to receiving the list of selected applications and in accordance with a determination that a relationship between the first computer system and the second computer system meets a second set of one or more criteria (e.g., does not meet the first set of one or more criteria or meets a different set of criteria), the computer system forgoes sending, to the second computer system, the first list of version identifiers. In some examples, the second set of one or more criteria includes a criterion that is met when the first computer system has not previously sent an archive of an application to the second computer system. In some examples, the second set of one or more criteria includes a criterion that is met when the first computer system has not previously paired with the second computer system. In some examples, each version identifier corresponds to a different application in the list of selected applications. In some examples, the first list is a sorted list, an ordered list, and/or an unordered list. In some examples, the first set of one or more criteria includes a criterion that is met when the first computer system has previously sent one or more archives of applications to the second computer system. In some examples, the first set of one or more criteria includes a criterion that is met when the first computer system is paired with the second computer system. In some examples, a version identifier includes a string of one or more alphanumerical characters indicating a version (e.g., “5.5a”).

At 708, after (e.g., during a communication session and/or while waiting on a response to sending the first list of version identifiers) sending the first list of version identifiers, the first computer system receives (e.g., via the short-range communication channel and/or via an intermediary device), from the second computer system, a communication (e.g., a message and/or a response).

At 710, in response to receiving the communication and in accordance with a determination that the communication includes a third list (e.g., a group, a map, a data structure, a collection, and/or a set) of version identifiers corresponding to a respective application in the list of selected applications, the first computer system sends (e.g., via the short-range communication channel), to the second computer system, data (e.g., a respective list of version identifiers different from the first list of version identifiers (and different from the second list of version identifiers), the respective list corresponding to a subset of data or a portion of an archive corresponding to the respective application) corresponding to the respective application. In some examples, each version identifier in the respective list of version identifiers corresponds to a different portion of an archive of the respective application. In some examples, the respective list of version identifiers includes a plurality of version identifiers. In some examples, the steps of method 700 described above occur during a single communication session. In some examples, the respective list is a sorted list, an ordered list, and/or an unordered list.

At 712, in response to receiving the communication and in accordance with a determination that the communication includes a confirmation that the first list of version identifiers matched a second list of version identifiers of (e.g., generated and/or stored by) the second computer system (e.g., the second computer system compares the first list of version identifiers with a second list of version identifiers generated and/or stored by the second computer system), the first computer system forgoes sending, to the second computer system, the data.

In some examples, in response to receiving the list of selected applications and in accordance with a determination that the relationship between the first computer system and the second computer system does not meet the first set of one or more criteria, the first computer system sends (e.g., to the second computer system) an archive for an application (e.g., data corresponding to the application) in the list of selected applications. In some examples, the archive includes user-interface view (e.g., corresponding to the application) configuration, snapshot configuration for a user-interface view, descriptors and/or extension information, an icon image, a timeline, a snapshot of a user-interface view, and/or a placeholder image. In some examples, the first set of one or more criteria includes a criterion that is not met when the first computer system has not previously sent an archive (e.g., for an application) to the second computer system. In some examples, the first set of one or more criteria includes a criterion that is not met when the first computer system does not have a record of a relationship with the second computer system. In some examples, the first set of one or more criteria includes a criterion that is not met when the first computer system does not have an existing pairing with the second computer system. In some examples, in response to receiving the list of selected applications and in accordance with a determination that the relationship between the first computer system and the second computer system does not meet the first set of one or more criteria, the first computer system sends (e.g., to the second computer system) a plurality of archives (e.g., a different archive for each application in the list of selected applications).

In some examples, after (e.g., during a communication session and/or while waiting on a response to sending the data to the second computer system) sending the data to the second computer system, the first computer system receives (e.g., from the second computer system) at least a portion (e.g., configuration information corresponding to the second computer system) of an archive, wherein the archive corresponds to a respective application in the list of selected applications. In some examples, the portion of the archive corresponds to an update of the archive. In some examples, the portion of the archive corresponds to a portion of the archive associated with (e.g., designated to and/or writable by) the second computer system. In some examples, the portion of the archive is used by the second computer system to display a user-interface view corresponding to the respective application. In some examples, the portion of the archive is not used by the first computer system to display a user-interface view corresponding to the respective application for display by the first computer system. In some examples, the portion of the archive is used by the first computer system to generate a user-interface view corresponding to the respective application for display by the second computer system. In some examples, the portion of the archive is used by the second computer system to display a user-interface view corresponding to the respective application.

In some examples, an available application in the list of available applications is installed on (e.g., by and/or with respect to) the first computer system (e.g., the available application is included in the list of available applications because the available application is installed on the first computer system). In some examples, the available application corresponds to a user-interface view (e.g., a user-interface view of a widget) that is displayed by the first computer system and/or the second computer system. In some examples, each application in the list of available applications is installed on the first computer system. In some examples, a plurality but not all applications in the list of available applications is installed on the first computer system. In some examples, at least one application in the list of available applications is not installed on the first computer system.

In some examples, the data includes a third list of version identifiers (e.g., a version identifier for each record in a data type) or a portion of a respective archive corresponding to a respective application in the list of selected applications. In some examples, the data includes the third list of version identifiers when the second computer system determines that the first list of version identifiers do not match a corresponding list of version identifiers stored by the second computer system. In some examples, the data includes the portion of the respective archive when the second computer system determines that the first computer system is missing and/or has incorrect data for the respective archive and that missing and/or incorrect data is managed by the second computer system.

In some examples, the respective archive (e.g., the portion and/or a different portion) includes a timeline (e.g., a predetermined timing and/or a predetermined sequence) for what to display (e.g., by the second computer system) at one or more different times (e.g., for a user-interface view corresponding to the respective application). In some examples, the timeline includes what to display at a plurality of different times in accordance with different sets of criteria being met.

In some examples, the respective archive (e.g., the portion and/or a different portion) includes a rendered graphical user interface to be displayed by the second computing system.

In some examples, the portion of the respective archive includes a configuration for a user-interface view corresponding to the respective application to be used by the second computer system to display the user-interface view.

In some examples, a first portion of the respective archive is read only for the first computer system (e.g., and not read only for the second computer system). In some examples, a second portion of the respective archive is read only for the second computer system (e.g., and not read only for the first computer system). In some examples, the first portion of the respective archive is readable and writeable by the second computer system. In some examples, the second portion of the respective archive is readable and writeable by the first computer system. In some examples, the first computer system is configured to modify the second portion. In some examples, the second computer system is configured to modify the first portion.

In some examples, after sending the list of available applications to the first computer system (e.g., in response to detecting that the second computer system is within a predefined distance from the first computer system) (e.g., in response to detecting the second computer system after ceasing to detect and/or communicate with the second computer system) (e.g., in response to initiating a communication session (e.g., a different communication session than a communication session used to send the list of available applications)) and in accordance with a determination that the relationship between the first computer system and the second computer system meets the first set of one or more criteria, the first computer system re-sends, to the second computer system, the list of available applications. In some examples, after sending the list of available applications to the first computer system and in accordance with a determination that the relationship between the first computer system and the second computer system meets the first set of one or more criteria, sending, to the second computer system, an updated list of available applications, wherein the updated list of available applications includes more, less, or at least one different application than the list of available applications.

In some examples, a version identifier of the first list of version identifiers includes a hash of data stored on a fourth computer system (e.g., the first computer system and/or the second computer system).

In some examples, the first computer system sends (e.g., at the first computer system), to a third computer system different from the first computer system and the second computer system, the list of available applications. In some examples, after sending the list of available applications, the first computer system receives, from the third computer system, a second list of selected applications from the list of available applications, wherein the second list of selected applications is different from the list of selected applications. In some examples, other operations described above are performed with respect to the third computer system. In some examples, the third computer system is the same type of computer system as the second computer system. In some examples, the third computer system a different type of computer system (e.g., has different capabilities) than the second computer system.

In some examples, one or more applications included in the list of available applications are not included in the list of selected applications. In some examples, data corresponding to the one or more applications is not communicated between the computer systems after sending the list of available applications. In some examples, placeholders and/or representations of the one or more applications are sent with the list of available applications or after sending the list of available applications (e.g., once it is determined that the one or more applications are not selected).

In some examples, an identifier of the first computer system and/or the second computer system are sent with communications. For example, the list of available applications can be sent with an identifier of the first computer system. for another example, the list of selected applications can be sent with an identifier of the second computer system. Including an identifier with communications allows another computer system to differentiate communications from different computer systems.

In some examples, the second computer system performed one or more operations described above with respect to other computer systems different from the first computer system.

In some examples, instead of an archive, a view template is sent for an application that includes one or more links to remote data sources that are used by a framework (e.g., executing on the first computer system and/or the second computer system) to obtain data from the remote data sources when processing the view template to render a view.

Note that details of the processes described above with respect to method 700 (e.g., FIG. 7) are also applicable in an analogous manner to other methods described herein. For example, method 800 optionally includes one or more of the characteristics of the various methods described above with reference to method 700. For example, the second configuration data of method 800 can included in the data sent between the first computer system and the second computer system of method 700. For brevity, these details are not repeated below.

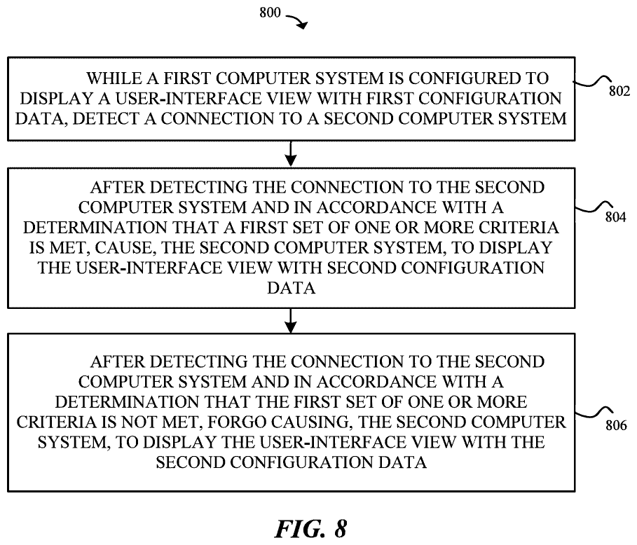

FIG. 8 is a flow diagram illustrating a method (e.g., method 800) for configuring a user-interface view for a particular computer system in accordance with some examples. Some operations in method 800 are, optionally, combined, the orders of some operations are, optionally, changed, and some operations are, optionally, omitted.

In some examples, method 800 is performed at a first computer system (e.g., a source computer system that acts as a source of data for a remote computer system (e.g., the second computer system)) (e.g., via a system process (e.g., an operating system process) that is different from one or more applications executing and/or installed on the first computer system). In some examples, the first computer system is a phone, a tablet, a laptop, a desktop computer, or a wearable device.

At 802, while the first computer system is configured to display a user-interface view (e.g., a user-interface view of a widget and/or one or more graphical user-interface elements) with first configuration data (e.g., received via input (e.g., a tap input or a non-tap input, such as a swipe input, a gaze input, and/or a hold and press input) detected by the first computer system), the first computer system detects a connection (e.g., via a short-range communication channel, such as WiFi or Bluetooth) to a second computer system (e.g., a communal computer system and/or a remote computer system that presents data from the first computer system) different from the first computer system. In some examples, the user-interface view, when displayed by the first computer system, is managed by (e.g., directed by, associated with, and/or corresponding to) a system process (e.g., an operating system process such as a daemon that manages interactions between a renderer of the first computer system and one or more applications). In some examples, the system process performs the steps of method 800. In some examples, the user-interface view is displayed by a renderer of the first computer system, with the system process instructing the renderer what to display. In some examples, the system process causes the user-interface view to be displayed by the first computer system. In some examples, before the first computer system displays the user-interface view, the user-interface view is stored by the system process to be displayed in accordance with a determination that a first set of one or more display criteria are met. In some examples, a process different from the system process (e.g., a different system process and/or a process that is not a system process and instead a user process (e.g., application process)) causes the user-interface view to be displayed by the first computer system. In some examples, the user-interface view is displayed (1) on a lockscreen of the first computer system (e.g., while the first computer system is in a locked state, with a reduced number of accessible features than when in an unlocked state), (2) on a homescreen of the first computer system (e.g., while the first computer system is displaying one or more user-interface elements that, when selected, cause a user interface of a corresponding application to be displayed by the first computer system), (3) in a respective user interface of a respective application executing on the first computer system, the respective application different from an application corresponding to the user-interface view, and/or (4) in a notification user interface of the first computer system (e.g., while the first computer system is displaying one or more notifications received by the first computer system from one or more processes (e.g., a process executing on the first computer system and/or a process executing on a computer system different from the first computer system)).

At 804, after (e.g., during a communication session (and, in some examples, in response to)) detecting the connection to the second computer system and in accordance with a determination that a first set of one or more criteria is met, the first computer system causes, the second computer system, to display the user-interface view with second configuration data (e.g., received from the second computer system) different from the first configuration data, wherein the second configuration data is corresponds (e.g., specific, relates, and/or with respect) to (e.g., indicates how the user-interface view should be displayed via the second computer system) the second computer system. In some examples, the user-interface view, when displayed by the second computer system, is managed by (e.g., directed by, associated with, and/or corresponding to) a system process (e.g., an operating system process such as a daemon that manages interactions between a renderer of the second computer system and one or more applications). In some examples, the user-interface view is displayed by a renderer of the second computer system, with the system process of the second computer system instructing the renderer of the second computer system what to display. In some examples, the system process of the second computer system causes the user-interface view to be displayed by the second computer system. In some examples, before the second computer system displays the user-interface view, the user-interface view is stored by the system process of the second computer system to be displayed in accordance with a determination that a first set of one or more display criteria are met. In some examples, a process different from the system process (e.g., a different system process and/or a process that is not a system process and instead a user process (e.g., application process)) of the second computer system causes the user-interface view to be displayed by the second computer system. In some examples, the user-interface view is displayed (1) on a lockscreen of the second computer system (e.g., while the second computer system is in a locked state, with a reduced number of accessible features than when in an unlocked state), (2) on a homescreen of the second computer system (e.g., while the second computer system is displaying one or more user-interface elements that, when selected, cause a user interface of a corresponding application to be displayed by the second computer system), (3) in a respective user interface of a respective application executing on the second computer system, the respective application different from an application corresponding to the user-interface view, and/or (4) in a notification user interface of the second computer system (e.g., while the second computer system is displaying one or more notifications received by the second computer system from one or more processes (e.g., a process executing on the second computer system and/or a process executing on a computer system different from the second computer system)). In some examples, displaying the user-interface view with the second configuration data causes the user-interface view to look visually different from displaying the user-interface view with the first configuration data. In some examples, displaying the user-interface view with the second configuration data causes the user-interface view to include information and/or data that is not included in the user-interface view when displayed with the first configuration data. In some examples, the first set of one or more criteria includes a criterion that is met when the first computer system and the second computer system have a first relationship (e.g., paired) with each other. In some examples, the first set of one or more criteria includes a criterion that is met when the first computer system has previously communicated with the second computer system. In some examples, the first set of one or more criteria includes a criterion (e.g., in addition to or instead of proximity of the first computer system to the second computer system) that is met when the second computer system is on the same network as the first computer system.

At 806, after (e.g., during the communication session (and, in some examples, in response to)) detecting the connection to the second computer system and in accordance with a determination that the first set of one or more criteria is not met, the first computer system forgoes causing, the second computer system, to display the user-interface view with the second configuration data. In some examples, in accordance with a determination that the first set of one or more criteria is not met. forgoing causing, the second computer system, to display the user-interface view (e.g., the user-interface view is not caused to be displayed). In some examples, the second computer system is not caused to display a user-interface view with the second configuration data without the first computer system detecting connection to the second computer system, irrespective of whether the first set of one or more criteria is met. In some examples, in conjunction with (e.g., after, while, and/or before) the first computer system forgoes causing, the second computer system, to display the user-interface view with the second configuration data, the second computer system does not display a user-interface view with the second configuration data.

In some examples, the connection is via a short-range wireless channel (e.g., Bluetooth, WiFi, and/or NFC).

In some examples, in response to detecting a connection with a third computer system (e.g., a different communal device) different from the second computer system and the first computer system, the first computer system causes (e.g., by the first computer system) the third computer system to display the user-interface view with third data configuration data corresponding to (e.g., specific to) the third computer system.

In some examples, the first computer system causes the second computer system to display the user-interface view with the second configuration data while causing the third computer system to display the user-interface view with the third configuration data. In some examples, the first computer system displays the user-interface view with the first configuration data while (1) the second computer system displays the user-interface view with the second configuration data and/or (2) the third computer system displays the user-interface view with the third configuration data.

In some examples, the first computer system displays (e.g., at the first computer system) the user-interface view with information corresponding to a location detected by the first device. In some examples, the first computer system causes (e.g., at the first computer system) the second computer system to display the user-interface view with information corresponding to a location specified in a communication received from the second computer system. In some examples, a different type of data other than location is used, such as time zone, a particular calendar, an area of a home and/or set of accessories, and/or one or more selected stocks. In some examples, the location specified in the communication received from the second computer system is different from the location detected by the first device.

In some examples, the first computer system causes the second computer system to display the user-interface view without detecting user input (e.g., without detecting input via the first computer system and/or the second computer) (e.g., in response to detecting the second computer system is within a predetermined distance from the first computer system) (e.g., automatically).

In some examples, the first computer system causes the second computer system to display the user-interface view with the second configuration data while the first computer system is displaying the user-interface view with the first data configuration.

In some examples, the first set of one or more criteria includes a criterion that is met when the second computer system is within a predefined distance from the first computer system.

In some examples, causing the second computer system to display the user-interface view includes initiating a process (e.g., as described above with respect to method 700) to synchronize a version of the user interface-view stored on the second computer system to a version of the user-interface view stored on the first computer system (e.g., the version of the user-interface view stored on the first computer system corresponds to the version of the user-interface view stored on the second computer system). In some examples, the version of the user-interface view stored on the first computer system is specific to the second computer system.

Note that details of the processes described above with respect to method 800 (e.g., FIG. 8) are also applicable in an analogous manner to other methods described herein. For example, method 900 optionally includes one or more of the characteristics of the various methods described above with reference to method 800. For example, the portion of the archive of method 900 can be the second configuration data of method 800. For brevity, these details are not repeated below.

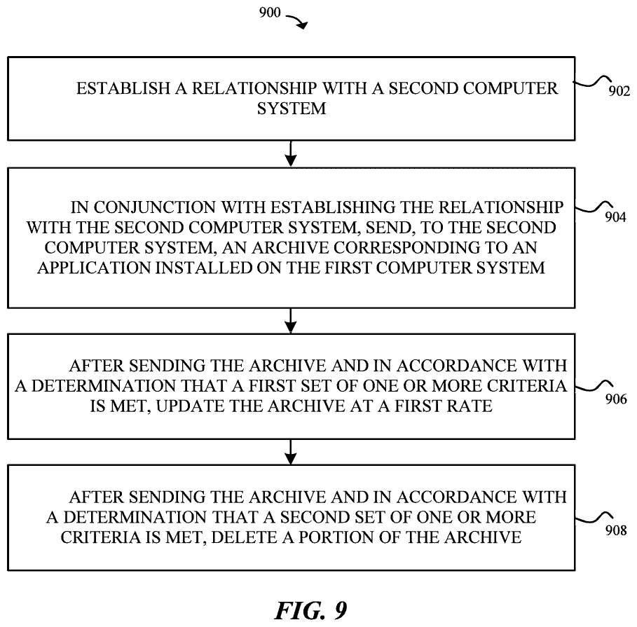

FIG. 9 is a flow diagram illustrating a method (e.g., method 900) for removal of an archive in accordance with some examples. Some operations in method 900 are, optionally, combined, the orders of some operations are, optionally, changed, and some operations are, optionally, omitted.

In some examples, method 900 is performed at a first computer system (e.g., a source computer system that acts as a source of data for a remote computer system (e.g., the second computer system)) (e.g., via a system process (e.g., an operating system process) that is different from one or more applications executing and/or installed on the first computer system). In some examples, the first computer system is a phone, a tablet, a laptop, a desktop computer, or a wearable device.

At 902, the first computer system establishes (e.g., via a short-range communication channel, such as WiFi, Bluetooth, or NFC) a relationship (e.g., as described above as a paired relationship with respect to method 700) with a second computer system (e.g., a communal computer system and/or a remote computer system that presents data from the first computer system) different from the first computer system.

At 904, in conjunction with (e.g., before e.g., immediately before and/or within a predetermined amount (e.g., 0.1-10 seconds) of time before, during, and/or after (e.g., immediately after and/or within a predetermined amount (e.g., 0.1-10 seconds) of time after)) establishing the relationship with the second computer system, the first computer system sends, to the second computer system, an archive (e.g., a collection of data) corresponding to an application (e.g., an application or an extension of an application as described above with respect to method 800) installed on the first computer system. In some examples, the archive is sent to the second computer system in response to receiving an indication that the second computer system selected the application (e.g., via input (e.g., a tap input or a non-tap input, such as a swipe input, a gaze input, and/or a hold and press input) received by the second computer system) as described above with respect to method 700.

At 906, after sending the archive (e.g., after no longer communicating with the second computer system and/or after ending a communication session with the second computer system) and in accordance with a determination that a first set of one or more criteria is met, wherein the first set of one or more criteria includes a criterion that is met when a first of amount of time has passed (e.g., 2 days, 1 week, or 2 weeks) since the first computer system has last communicated (e.g., previously communicated and/or previously sent data to and/or received data from) with the second computer system, the first computer system updates the archive (e.g., a local copy of the archive stored by the first computer system) at a first rate (e.g., once per minute, once per hour, or twice per day) (e.g., the first computer system updates the archive at a predefined cadence and/or repeatedly in response to a predefined amount of time passing). In some examples, updating the archive includes updating a user-interface view corresponding to the archive. In some examples, updating the archive includes changing data corresponding to the archive to reflect current data that, in some examples, is in accordance with configuration data corresponding to the second computer system. In some examples, updating the archive is with respect to portions that would need to be updated before sending the archive to and/or causing a user interface corresponding to the archive to be displayed by the second computer system.

At 908, after sending the archive (e.g., after no longer communicating with the second computer system and/or after ending a communication session with the second computer system) and in accordance with a determination that a second set of one or more criteria is met different from the first set of one or more criteria, wherein the second set of one or more criteria includes a criterion that is met when a second of amount of time, different from the first amount of time, has passed (e.g., 4 days, 2 weeks, or 1 month) since the first computer system has last communicated with the second computer system, the first computer system deletes a portion (e.g., configuration data, as described above with respect to method 800) of the archive (e.g., that is stored by the first computer system and, in some examples, that was received from the second computer system). In some examples, the portion corresponds to the second computer system. In some examples, the portion is stored by the second computer system. In some examples, in accordance with a determination that the second set of one or more criteria is met, forgoing updating the archive at the first rate. In some examples, in accordance with a determination that the first set of one or more criteria is met, forgoing deleting the portion of the archive.

In some examples, after sending the archive and in accordance with a determination that a third set of one or more criteria is met, wherein the third set of one or more criteria includes a criterion that is met when a third amount of time, different from (e.g., longer and/or shorter than) the first amount of time and the second amount of time, has passed since the first computer system has last communicated with the second computer system, the first computer system updates the archive at a second (e.g., faster, slower, or different) rate different from the first rate.

In some examples, after sending the archive and in accordance with a determination that a fourth set of one or more criteria is met, wherein the fourth set of one or more criteria includes a criterion that is met when a fourth amount of time, different from (e.g., longer and/or shorter than) the first amount of time and the second amount of time (e.g., and the third amount of time), has passed since the first computer system has last communicated with the second computer system, the first computer system deletes (e.g., from the first computer system) the archive.

In some examples, the archive corresponds to a user-interface view displayed by the second computer system.

In some examples, updating the archive (e.g., at the first rate and/or the second rate) includes changing (e.g., by the first computer system) what is to be displayed by the second computer system (e.g., after subsequently communicating with the second computer system).

In some examples, in response to connecting to the second computer system, the first computer system sends (e.g., at the first computer system), to the second computer system, updates with respect to the archive.

In some examples, before sending the updates with respect to the archive, the first computer system separately updates the archive a plurality of times such that the updates includes a plurality of different updates. In some examples, each individual update is not sent because the second computer system does not communicate with the first computer system before subsequent updates are made.

Note that details of the processes described above with respect to method 900 (e.g., FIG. 9) are also applicable in an analogous manner to the methods described herein. For example, method 600 optionally includes one or more of the characteristics of the various methods described above with reference to method 900. For example, the portion of the archive of method 900 be included in the data sent to the second computer system of method 700. For brevity, these details are not repeated below.

Attention is now directed to techniques for reducing power consumption. Such techniques can be used to prevent and/or change a rate for locally updating and/or sending content to other devices.

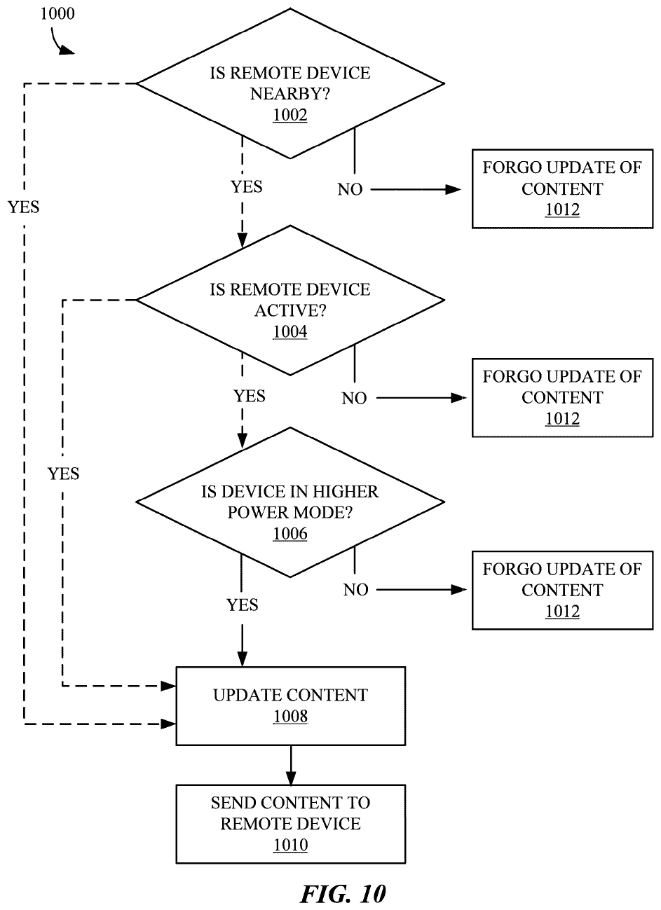

FIG. 10 is a flow diagram illustrating a process (e.g., process 1000) for a device to update content for another device in accordance with some examples. Some operations in process 1000 are, optionally, combined, changed, and/or omitted.

Process 1000 is described with respect to the context above of a source device (e.g., source device 300 and/or source device 402) locally updating content for an archive of an application and sending the updated content to a remote device (e.g., first remote device 310, second remote device 320, and/or remote device 404). It should be recognized that other types of data can be used with techniques described herein and that content for an archive of an application is just used as an example.

In some examples, process 1000 is performed at the source device while the source device is acting as a source of data (e.g., the archive, as described above) for the remote device. For example, a system process (e.g., an operating system process and/or a background process) of the source device can perform process 1000 on behalf of one or more applications of the source device including the application that corresponds to the archive. Process 1000 can reduce (1) a power cost of the source device to update and/or send the content and/or (2) a power cost of the remote device to receive and/or process the content.

In some examples, the source device updates the content in two different manners. One manner includes the source device actively refreshing the content as a result of the content being requested by either an application of the source device or the remote device. Another manner includes the source device passively refreshing the content as a result of certain criteria being satisfied, as further described below with respect to process 1000.

In some examples, an active refresh is triggered by either the source device or the remote device and results in the content being updated and/or used (e.g., displayed). For example, if the remote device wakes from an inactive state (e.g., sleep mode) and determines that the content being displayed by the remote device is stale (e.g., after a period of inactivity (e.g., 0-15 min)), the remote device can trigger an active refresh (e.g., forced refresh) of the content. In some examples, active refreshes are not subject to a ceiling (e.g., the refresh is triggered regardless of the number of times the remote device wakes from the inactive state). Once the refresh is complete, the source device sends the updated content to the remote device.

In some examples, a passive refresh is triggered by the source device and results in the content being updated. In such examples, the content can be updated with or without it being sent and/or displayed as a result (e.g., a direct result, such that the content is sent and/or displayed as a result of another event). In some examples, a passive refresh is performed in the background (e.g., on a background thread, in asynchronous batch updates, and/or without interrupting foreground applications).

In some examples, given the cost of updating content, the source device takes into account a last time that the source device updated the content to determine whether to perform a passive refresh. In such examples, the last time can be with respect to a request from the source device, the remote device, and/or another remote device as long as the update was for the same configuration. For example, an update of content for the source device can be used in place of an update of the content for the remote device. In some examples, whether to perform a passive refresh is based on a number of views of the content on the source device and/or the remote device. For example, if the number of views and/or accesses of the content for a particular application (e.g., weather widget and/or weather application) are higher in the morning than in the evening, more frequent passive refreshes can be performed in the morning.

In some examples, as described further below with respect to 1002, 1004, and/or 1006, the source device detects a state of the source device and/or the remote device to determine whether to passively update the content. In such examples, the content is updated at 1008 when 1002, 1004, and/or 1006 is satisfied and is not updated at 1012 when 1002, 1004, and/or 1006 is not satisfied. It should be recognized that the source device can use any combination of 1002, 1004, 1006, and/or other criteria to determine whether to passively update the content, such as whether it is currently a particular time of day (e.g., a user is more likely to view the content in the morning rather than at night), whether the content had received a predefined number of views within a predefined period of time, and/or whether the remote device and/or the source device is connected to a high bandwidth network.

At 1002, the source device detects whether the remote device is nearby the source device. This can allow the source device to update the content only when the remote device is within a certain proximity and likely to be accessed, rather than continuously updating regardless of proximity. The proximity detection can be periodic, such as checking for nearby devices every few minutes. In some examples, the proximity detection is performed by communicating over a short-range communication channel, such as Wi-Fi, Bluetooth and/or NFC. By leveraging proximity detection and only triggering passive content updates when the remote device is nearby, the source device can optimize power usage and/or network bandwidth while still ensuring that the user has access to up-to-date content on the remote device when it is likely to be accessed. For example, if the user has different configurations of a weather widget on the source device (e.g., showing the weather of a first location (e.g., San Francisco) on their phone) and on the remote device (e.g., showing the weather of a second location (e.g., Cupertino) on their home desktop), the source device does not update the content of the weather widget for the remote device unless the remote device is nearby the source device, such as the user being home and likely accessing the weather widget on the remote device. This can avoid unnecessary and/or expensive updates of content when the remote device is unlikely to be accessed within a certain amount of time.

At 1004, the source device detects an activity state of the remote device (e.g., active display and/or active application corresponding to the content of the source device). For example, the source device performs a first evaluation to determine whether a display of the remote device is active. In some examples, the display of the remote device is (1) active when the display is powered on and/or displaying content and (2) inactive when the display is powered off and/or not displaying content. For example, if the display of the remote device is off or on without displaying content corresponding to the source device, the source device does not update the content. For another example, the source device performs a second evaluation to determine whether the remote device is configured to display the content. This can involve checking if there is an integration, product association, link, and/or pairing between the remote device and an application corresponding to the content. If the remote device has no such configuration, the source device does not update the content. In some examples, the first evaluation of a display state of the remote device and the second evaluation of a configuration of the remote device are executed independently, concurrently, or in combination with another evaluation, such as checking whether a different criterion is satisfied by the activity state of the remote device (e.g., number of content and/or device accesses in a given period of time). The first evaluation and the second evaluation can be performed using information sent over the same short-range communication channel used at 1002. Alternatively, the first evaluation and the second evaluation can involve communication with another computer system, such as sending the evaluation queries to an intermediary server or cloud-based service that communicates with the remote device and relays the results back to the source device.

At 1006, the source device detects whether the source device and/or the remote device is in a higher power mode. In some examples, a power mode is a state of the device that affects its power consumption and/or potential performance and is, in some examples, independent of a current battery level of the device. For example, a lower power mode can result in reduction of processor speed, limits on background tasks, and/or certain features being turned off to conserve power. In some examples, the lower power mode can be activated manually by the user or automatically based on certain conditions, such as when the battery level falls below a certain threshold (and/or while not being connected to a power source). In addition to or instead of checking its own power mode, the source device can also evaluate the power level of its battery (e.g., checking the percentage of remaining battery level) to determine if the source device has sufficient energy to warrant updating the content for the remote device. In some examples, the source device evaluates the power mode and/or power level of the remote device. This can be done by sending a request to the remote device over the short-range communication channel described above. The remote device can then respond to the source device with its current power mode setting and/or battery level.

In some examples, the source device combines a first evaluation of its own power mode, and a second evaluation of the power mode of the remote device to determine whether to update the content. Performing the first evaluation and the second evaluation allows the source device to compare the power modes of both devices to determine whether to proceed with updating the content. For example, if both devices are in the lower power mode, the source device can defer updating the content to conserve energy on both devices. For another example, if the source device is in the higher power mode and the remote device is in the lower power mode, the source device can choose to update the content if it determines that the update is critical and/or time-sensitive without sending the content to the remote device (and/or while scheduling sending the updated content to a later time and/or when the remote device is in a higher power mode). For another example, if the source device and the remote device are in the higher power mode, the source device can update the content (e.g., performs instant refreshes, and/or executes queued updates). In some examples, if the source device is in the lower power mode, the source device can lower the update frequency such as once per hour to conserve energy, and if the remote device is in the lower power mode, the source device will not immediately send updated content to avoid the power cost of receiving updated content on the remote device. In some examples, the source device can queue updates of content in a batch process to be executed when the source device is in the higher power mode.

At 1008, after the source device determines that 1002, 1004, 1006, and/or any other criteria described herein is positively satisfied, the source device proceeds to update the content. In some examples, the source device updates the content by fetching data and/or polling for updates from one or more devices (e.g., the remote device, and/or different remote device (e.g., cloud server)) and/or reconciliating data changes and/or updating versions between the source device and the remote device. In some examples, the source device updates the content by generating new content corresponding to the content such as generating and/or extending data fields, and/or configuring user interface elements and/or multimedia content.

In some examples, process 1000 adapts the rate at which content is updated depending on different criteria being satisfied, including as described above with respect to 1002, 1004 and/or 1006. In such examples, limiting passive updates of content can avoid the power cost of frequent generation and/or transmission of updated content. For example, the rate at which content is updated can be adjusted based on the power mode of the source device and/or the remote device. If the source device and/or the remote device is in the lower power mode, the rate can be decreased. If the source device and/or the remote device is in the higher power mode, the rate can be increased. For another example, the rate at which content is updated can be adjusted based on proximity of a device. If the remote device is not nearby the source device, the rate can be decreased. If the remote device is nearby the source device, the rate can be increased. For another example, the rate at which content is updated can be adjusted based on whether the content is frequently accessed. If the content is not frequently accessed, the rate can be decreased. If the content is frequently accessed, the rate can be increased. For another example, the rate at which content is updated can be adjusted based on whether the remote device is in an active or inactive state (e.g., whether content is displayed) and/or based on a last activity. If the remote device is not displaying content, the rate can be decreased. If the remote device is displaying content, the rate can be increased.

At 1010, the source device determines whether to send the updated content to the remote device in response to updating the content or at some point after updating the content when some criteria is satisfied. The determination can be based on a set of sending criteria, the same or similar to criteria described above with respect to updating content. For example, the source device can send updated content when the remote device is nearby, when the remote device and/or the source device is in an active state (e.g., screen is on and/or displaying relevant content), and/or when the source device and/or the remote device is in a higher power mode. For another example, the source device can defer sending the updated content to the remote device when the source device and/or the remote device is in a lower power mode, the remote device is not proximate to the source device, and/or the remote device is not actively displaying relevant content (e.g., screen is off and/or displaying content that is not relevant to the content that was updated). Delaying the content transfer in such situations helps conserve power and/or optimize resource utilization on both devices. In some examples, given the cost of sending content for multiple applications to a single device, the source device consolidates refreshes of content for different applications and coalesces updates into one transfer directed to the single device.

In some examples, the source device sends the content to the remote device via a short-range communication channel (e.g., Wi-Fi, Bluetooth, and/or NFC). In some examples, the source device optimizes content for transfer before sending the updated content to the remote device (e.g., via compression, secure encoding, and/or segmentation of the data). In some examples, the source device encodes and/or transforms the content into a content format expected by the remote device before sending the content (e.g., adjusting resolution, and/or converting file formats (e.g., converting to binaries, URLs, and/or device friendly formats)). In some examples, the source device employs one or more encryption methods (e.g., SSL/TLS protocols, token-based encryption, hashing, secret sharing, and/or digital signatures) to send the content to the remote device.

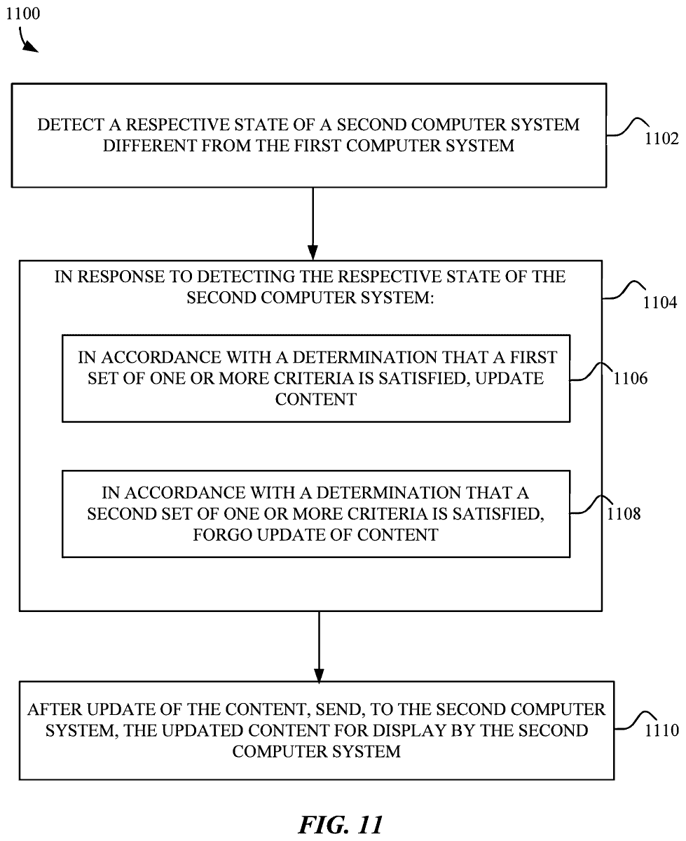

FIG. 11 is a flow diagram illustrating a method (e.g., method 1100) for a device to update content for another device in accordance with some examples. Some operations in method 1100 are, optionally, combined, the orders of some operations are, optionally, changed, and some operations are, optionally, omitted.

As described below, method 1100 provides an intuitive way for a device to update content for another device. Method 1100 reduces the cognitive burden on a user, thereby creating a more efficient human-machine interface. For battery-operated computing devices, enabling a user to interact with such devices faster and more efficiently conserves power and increases the time between battery charges.

In some examples, method 1100 is performed at a first computer system (e.g., a smart phone, a smart watch, a smart display, a tablet, a laptop, a fitness tracking device, a head-mounted display (HMD) device, a communal device, a media device, a speaker, a television, and/or a personal computing device) (e.g., 300 and/or 402).

The first computer system detects (1102) a respective state (e.g., operational status, power state, proximity to the first computer system, a configuration, a user engagement, and/or pairing state) (e.g., as described above with respect to FIG. 10, such as 1002, 1004, and/or 1006) of a second computer system (e.g., a smart phone, a smart watch, a smart display, a tablet, a laptop, a fitness tracking device, a head-mounted display (HMD) device, a communal device, a media device, a speaker, a television, and/or a personal computing device) (e.g., 310, 320, 404, and/or 1200) different from the first computer system.

In response to (1104) detecting the respective state of the second computer system, in accordance with a determination that a first set of one or more criteria is satisfied (e.g., the respective state is a first state, the second computer system is nearby (e.g., within 0-10 feet and/or short-wireless communication), is configured with (e.g., to display) the widget, has an active display, is not in low power mode, is connected to a power source, is experiencing a high-bandwidth network connection, has sufficient storage capacity, and/or has not recently interacted with the first computer system) (e.g., yes to 1002, 1004, and/or 1006), the first computer system updates (1106) (e.g., background updates, refreshes, synchronizes, downloads, regenerates, and/or localizes) content (e.g., graphical components, dynamic elements, widget data, multimedia content, alerts, and/or real-time data (e.g., traffic data, weather data, and/or stock data)) (e.g., of a widget) (e.g., in the background) (e.g., as described above with respect to 418, 602, 610, and/or 1008). In some examples, updating the content includes requesting and/or obtaining updated and/or latest content from another computer system different from the first computer system and the second computer system.

In response to (1104) detecting the respective state of the second computer system, in accordance with a determination that a second set of one or more criteria (e.g., the respective state is a second state different from the first state, the second computer system is not nearby, is not configured with the widget, the content does not have an update, has an inactive display, is turned off, is in low power mode, is not connected to a power source, is experiencing a low-bandwidth network connection, has insufficient storage capacity, and/or has recently interacted with the first computer system) (e.g., no to 1002, 1004, and/or 1006), different from the first set of one or more criteria, is satisfied, the first computer system forgoes (1108) update of the content (e.g., 1012). In some examples, in response to detecting the respective state of the second computer system and in accordance with a determination that the second set of one or more criteria is satisfied, the first computer system forgoes requesting and/or obtaining updated content from the other computer system. In some examples, in response to detecting the respective state of the second computer system and in accordance with a determination that the second set of one or more criteria is satisfied, the first computer system requests and/or obtains updated content from the other computer system at a reduced rate (e.g., performs batch updates, performs an update at a reduced schedule (e.g., once an hour, and/or once a day)).

After updating the content, the first computer system sends (1110) (e.g., transmits using a wireless communication protocol), to the second computer system, the updated content for display by the second computer system (e.g., without causing the second computer system to display the updated content, and/or storing the updated content locally on the second computer system) (e.g., 1010).

In some examples, the content is a portion of (e.g., nested in, populated in, embedded in, and/or child element of) (e.g., feeds, and/or populates) a representation (e.g., widget and/or shortcut application) of an application (e.g., program, and/or foreground application) of the second computer system (and/or the first computer system).

In some examples, the first computer system is in communication with (and/or includes) a display generation component (e.g., a display screen, a projector, and/or a touch-sensitive display). In some examples, the second computer system does not include and/or is not in communication with the display generation component. In some examples, the first computer system displays, via the display generation component, the content (e.g., before, while, and/or after detecting the respective state of the second computer system) (e.g., before updating the content) (and/or the updated content (e.g., after updating and/or in conjunction with (e.g., before, while, and/or after) sending the updated content to the second computer system)). In some examples, the content includes static information (e.g., user information and/or a device setting), frequently updated data (e.g., stock price and/or weather data), an interactive element (e.g., a button and/or a menu), and/or multimedia content (e.g., image, and/or video). In some examples, the content includes recently accessed content. In some examples, the content includes aggregated and/or cached data.

In some examples, the updated content (and/or the content) is not displayed by the first computer system. In some examples, the first computer system locally stores the content without displaying it on a user interface. In some examples, the content is included in a user interface of an application. In some examples, the first computer system processes (e.g., updates, generates, and/or formats) the content (and/or the updated content) for the second computer system (e.g., notification generation, personalized recommendation, and/or display on an application installed on the second computer system and, in some examples, not installed on the first computer system).

In some examples, the respective state of the second computer system includes a distance (e.g., short distance and/or 0-20 feet) of the second computer system from the first computer system (e.g., as described above with respect to 1002). In some examples, the first set of one or more criteria includes a criterion that is satisfied when the distance is within a threshold distance (e.g., nearby, such as within 0-20 feet). In some examples, the second set of one or more criteria includes a criterion that is satisfied when the distance is not within the threshold distance. In some examples, the first computer system prioritizes updating content relevant to nearby computer systems (e.g., the second computer system when the second computer system is within the threshold distance). In some examples, the second computer system combines distance-based sensing (e.g., Bluetooth, and/or NFC) with network connectivity information to determine the respective state of the second computer system and/or the distance of the second computer system from the first computer system. In some examples, the first computer system uses proximity data to trigger content update and/or content sharing.

In some examples, the respective state of the second computer system includes a display state (e.g., active, active on a specific application, and/or active within a period of time) of the second computer system (e.g., as described above with respect to 1004). In some examples, the first set of one or more criteria includes a criterion that is satisfied when the display state is a first state (e.g., active, on, active on a specific application, and/or active within a period of time). In some examples, the second set of one or more criteria includes a criterion that is satisfied when the display state is a second state (e.g., inactive, off, and/or inactive on a specific application) different from the first state. In some examples, the first computer system updates and/or sends content in accordance with a determination that the second computer system has an active display. In some examples, the first computer system updates and/or sends content in accordance with a determination that the second computer system has an active display on a specific application (e.g., an application that the first computer system has content corresponding to the application). In some examples, the first computer system updates and/or sends content in accordance with a determination that the second computer system had an active display within a period of time (e.g., 0-10 min and/or had at least an interaction within 0-1 hour). In some examples, the first computer system forgoes update and/or sending content in accordance with a determination that the second computer system has an inactive display. In some examples, the first computer system forgoes update and/or sending content in accordance with a determination that the second computer system has an inactive display of a specific application (e.g., the second computer system has not had an interaction on an application displayed in a period of time (e.g., 0-10 min and/or 0-1 hour)).

In some examples, the respective state of the second computer system includes a configuration (e.g., installation and/or display) of an application corresponding to the content (e.g., as described above with respect to 1004). In some examples, the first set of one or more criteria includes a criterion that is satisfied when the second computer system is configured with the application corresponding to the content (e.g., the application is installed on and/or a user interface of the second computer system is configured to display a user interface of the application and/or the content). In some examples, the second set of one or more criteria includes a criterion that is satisfied when the second computer system is not configured with the application corresponding to the content (e.g., the application is not installed on and/or a user interface of the second computer system is not configured to display a user interface of the application and/or the content) (e.g., the application is installed on and a user interface of the second computer system is not configured to display a user interface of the application and/or the content). In some examples, the first computer system forgoes update and/or sending of content not configured with an application corresponding to the content (e.g., the second computer system does not have an application installed corresponding to (e.g., relevant to, and/or requires) the content). In some examples, the first computer system processes and/or adapts the content to the application of the second computer system corresponding to the content (e.g., the first computer system selectively updates and/or sends stale data, specific pieces of data to be displayed and/or missing data).

In some examples, detecting the respective state of the second computer system includes receiving a message (e.g., a data packet, a beacon signal, and/or a broadcast) from the second computer system (e.g., via a short-range communication channel) (e.g., Wi-Fi, Bluetooth, and/or NFC). In some examples, the message received from the second computer system includes metadata about the state of the second computer system. In some examples, the message received from the second computer system includes a request for the content. In some examples, the first computer system establishes a secure connection with the second computer system after receiving the message. In some examples, the first computer system extracts proximity information from the message. In some examples, the message includes additional information about the second computer system including supported applications, available and/or unavailable content and/or pairing configurations. In some examples, the first set of one or more criteria is satisfied when the message is received (e.g., indicating proximity of the second computer system with the first computer system). In some examples, the second set of one or more criteria is satisfied when the message is not received (e.g., indicating lack of proximity of the second computer system with the first computer system). In some examples, before receiving the message from the second computer system, the first computer system sends a request (e.g., for the message) to the second computer system. In some examples, the second computer system sends the message to the first computer system in response to and/or as a result of receiving the request.

In some examples, detecting the respective state of the second computer system includes sending (e.g., broadcasting) a message (e.g., a data packet, a beacon signal, and/or a broadcast) including an identification (e.g., a MAC address, a UUID, a hash, a unique device signature, a SSID, and/or an IP address) of the first computer system (e.g., via a short-range communication channel) (e.g., Wi-Fi, Bluetooth, BLE, and/or NFC). In some examples, the first computer system adjusts broadcast frequency based on expected proximity and/or activity patterns (e.g., based on historical data, based on proximity, based on the time of the day, and/or based on type of content and/or corresponding application) of the second computer system (e.g., scheduled broadcasts, reduced or increased broadcast frequency). In some examples, the message from the second computer system is a response to the message including the identification of the first computer system. In some examples, the second computer system sends the message in response to and/or as a result of receiving the message including the identification. In some examples, the message including the identification is sent to the second computer system. In some examples, the message including the identification is generally broadcast (e.g., to one or more nearby computer systems, including the second computer system).

In some examples, the first computer system is in communication with (and/or includes) an input component (e.g., a camera, a depth sensor, a microphone, a hardware input mechanism, a rotatable input mechanism, a heart monitor, a temperature sensor, and/or a touch-sensitive surface). In some examples, sending (e.g., broadcasting) the message including the identification of the first computer system is performed without detecting, via the input component, an input (e.g., a user request) (e.g., a tap input and/or a non-tap input (e.g., a verbal input, an audible request, an audible command, an audible statement, a swipe input, a hold-and-drag input, a gaze input, an air gesture, and/or a mouse click)). In some examples, the first computer system sends the message periodically for continuous discovery of nearby computer systems. In some examples, the first computer system sends the message to automatically initiate proximity detection and/or state determination of another computer system (e.g., the second computer system). In some examples, the first computer system sends the message including the identification of the first computer system after detecting, via the input component, an input (e.g., a tap input and/or a non-tap input (e.g., a verbal input, an audible request, an audible command, an audible statement, a swipe input, a hold-and-drag input, a gaze input, an air gesture, and/or a mouse click)) (e.g., the first computer system and/or the second computer system are pre-configured to disable automatic device discovery (e.g., proximity and/or state discovery)).

In some examples, the content is updated (e.g., one or more times) in the background (e.g., asynchronously, on a schedule, and/or is performed in a batch job) (e.g., the content is updated in a background thread (e.g., non-blocking of foreground applications and/or tasks)). In some examples, the first computer system updates content asynchronously via one or more workers, without exhausting resources of the first computer system. In some examples, the first computer system updates content in the background periodically and/or when the second computer system is nearby.

In some examples, the first set of one or more criteria includes a first criterion that is satisfied when the first computer system is in a first mode (e.g., low power mode, high power mode, lower power mode, higher power mode, lower connectivity mode, higher connectivity mode, active display mode, locked mode, unlocked mode, notification mode, and/or inactive display mode) and the content was updated within a first predefined period of time (e.g., dynamic time window, predetermined time window, 0-10 min, and/or 1-2 days) (e.g., as described above with respect to 1006). In some examples, the first set of one or more criteria includes a second criterion, different from the first criterion, that is satisfied when the first computer system is in a second mode (e.g., low power mode, high power mode, lower power mode, higher power mode, lower connectivity mode, higher connectivity mode, active display mode, locked mode, unlocked mode, notification mode, and/or inactive display mode), different from the first mode, and the content was updated within a second predefined period of time (e.g., dynamic time window, predetermined time window, 0-10 min, and/or 1-2 days) different from (e.g., shorter or longer than) the first predefined period of time. In some examples, the first set of one or more criteria is satisfied when either the first criterion or the second criterion is satisfied. In some examples, the second set of one or more criteria is satisfied when the first criterion and the second criterion are not satisfied.

In some examples, the first set of one or more criteria includes a third criterion that is satisfied when the second computer system is in a third mode (e.g., low power mode, high power mode, lower power mode, higher power mode, lower connectivity mode, higher connectivity mode, active display mode, locked mode, unlocked mode, notification mode, and/or inactive display mode) and the content was updated within a third predefined period of time (e.g., dynamic time window, predetermined time window, 0-10 min, and/or 1-2 days) (e.g., as described above with respect to 1006). In some examples, the first set of one or more criteria includes a fourth criterion, different from the third criterion, that is satisfied when the second computer system is in a fourth mode (e.g., low power mode, high power mode, lower power mode, higher power mode, lower connectivity mode, higher connectivity mode, active display mode, locked mode, unlocked mode, notification mode, and/or inactive display mode), different from the third mode, and the content was updated within a fourth predefined period of time (e.g., dynamic time window, predetermined time window, 0-10 min, and/or 1-2 days) different from the third predefined period of time. In some examples, the first set of one or more criteria is satisfied when either the third criterion or the fourth criterion is satisfied. In some examples, the second set of one or more criteria is satisfied when the third criterion and the fourth criterion are not satisfied. In some examples, the third mode is the same as or different from the first mode. In some examples, the fourth mode is the same as or different from the second mode. In some examples, the third predefined period of time is the same as or different from the first predefined period of time. In some examples, fourth predefined period of time is the same as or different from the second predefined period of time.

In some examples, while the first set of one or more criteria is satisfied, the first computer system continues update of the content at a first rate (e.g., preconfigured rate of an application corresponding to the content, and/or preconfigured rate of the first computer system). In some examples, the first rate is adjusted based on dynamic changes within the first set of one or more criteria (e.g., based on power level, network bandwidth, and/or closeness of the second computer system). In some examples, the first rate is a negotiated rate (e.g., dynamically adjusted and/or agreed upon rate) with the second computer system. In some examples, the first rate is a default (e.g., preconfigured) rate of the first computer system, based on a power level, network bandwidth, storage and/or available processing bandwidth.

In some examples, while the first set of one or more criteria is satisfied, in accordance with a determination that a third computer system (e.g., the first computer system or the second computer system) is in a fifth mode (e.g., low power mode, high power mode, lower power mode, higher power mode, lower connectivity mode, higher connectivity mode, active display mode, locked mode, unlocked mode, notification mode, and/or inactive display mode), the first computer system continues update of the content at a second rate. In some examples, continuing update of the content at the second rate includes updating all portions of the content, fetching updates from one or more computer systems, and/or performing updates at a normal (e.g., ideal, and/or near real-time) frequency and/or schedule. In some examples, while the first set of one or more criteria is satisfied, in accordance with a determination that the third computer system is in a sixth mode (e.g., low power mode, high power mode, lower power mode, higher power mode, lower connectivity mode, higher connectivity mode, active display mode, locked mode, unlocked mode, notification mode, and/or inactive display mode), the first computer system continues update of the content at a third rate different from the second rate. In some examples, the third rate is a lower rate than the second rate (e.g., reduced schedule, and/or lower frequency of update). In some examples, continuing update of the content at the third rate includes updating essential portions of the content, fetching less updates from one or more computer systems, and/or performing updates at a lower frequency and/or reduced schedule as compared to continuing update of the content at the first rate.

In some examples, while the first set of one or more criteria is satisfied, in accordance with a determination that the content is to be displayed by the first computer system (e.g., rendered within an application and/or representation of an application, and/or populate a display of the first computer system), the first computer system continues update of the content at a fourth rate. In some examples, continuing update of the content at the fourth rate includes updating all portions of the content, fetching updates from one or more computer systems (e.g., image, video, text, and/or display information) and/or performing updates at a normal (e.g., ideal, and/or near real-time) frequency and/or schedule. In some examples, while the first set of one or more criteria is satisfied, in accordance with a determination that the content is not to be displayed by the first computer system, the first computer system continues update of the content at a fifth rate different from the fourth rate. In some examples, the fifth rate is a lower rate than the fourth rate (e.g., reduced schedule, and/or lower frequency of update). In some examples, continuing update of the content at the fifth rate includes updating essential portions of the content, fetching less updates from one or more computer systems, and/or performing updates at a lower frequency and/or reduced schedule as compared to continuing update of the content at the fourth rate.

In some examples, the first set of one or more criteria includes a criterion that is satisfied when the content has not been updated within a predefined period of time (e.g., a schedule and/or a time window (e.g., 0-10 min, and/or 1-2 days)). In some examples, the first set of one or more criteria includes a criterion that includes a determination that the content was not updated within a period of time. In some examples, the first set of one or more criteria includes a criterion that is satisfied when the content is determined to be stale (e.g., the first computer system detects available new data and/or version of the content). In some examples, the first set of one or more criteria includes a criterion that is satisfied when an event (e.g., an update is available) with respect to the content has occurred (e.g., one or more configurations of the content indicating incoming updates within a time window and/or schedule).

In some examples, the content corresponds to a user interface (e.g., the content is displayed within the user interface, such as a widget). In some examples, the first set of one or more criteria includes a criterion that is satisfied when a number of views (e.g., interactions, inputs, and/or application launches) of the user interface (and/or the content) on the second computer system exceeds a number threshold (e.g., 1-20 times) within a period of time (e.g., 1-100 minutes). In some examples, the number of views required by the criterion of the first set of one or more criteria is based on content type, user configuration, and/or usage context (e.g., higher threshold for less critical content and/or lower threshold for frequently accessed content and/or applications). In some examples, the first computer system and/or the second computer system dynamically updates the number threshold based on historical and/or real-time view count of the user interface and/or the content and/or launches of an application corresponding to the content.

In some examples, the updated content is not sent to the second computer system in response to updating the content. In some examples, the first computer system stores the updated content locally for a period of time. In some examples, the first computer system awaits for the first set of one or more criteria to be satisfied before sending the updated content. In some examples, the first computer system awaits a request from the second computer system before sending the updated content. In some examples, the first computer system sends a request to the second computer system for whether the second computer system needs updates to the content before sending the updated content.

In some examples, the respective state is a first respective state. In some examples, the content is first content. In some examples, the first computer system detects a second respective state (e.g., operational status, power state, proximity to the first computer system, a configuration, a user engagement, and/or pairing state) of a respective computer system (e.g., a smart phone, a smart watch, a smart display, a tablet, a laptop, a fitness tracking device, a head-mounted display (HMD) device, a communal device, a media device, a speaker, a television, and/or a personal computing device) different from the first computer system (and/or the second computer system). In some examples, in response to detecting the second respective state of the respective computer system, in accordance with a determination that a third set of one or more criteria is satisfied, wherein the third set of one or more criteria includes a criterion that is satisfied when the respective computer system is a third computer system (e.g., that the third computer system satisfies the first set of one or more criteria), the first computer system updates second content. In some examples, in response to detecting the second respective state of the respective computer system, in accordance with a determination that a fourth set of one or more criteria, different from the third set of one or more criteria, is satisfied, wherein the fourth set of one or more criteria includes a criterion that is satisfied when the respective computer system is a fourth computer system (e.g., that the fourth computer system satisfies the first set of one or more criteria) different from the third computer system, the first computer system updates third content different from the second content. In some examples, the third content is a portion of the second content (e.g., partial data (e.g., with higher priority and/or most essential data) and/or a set of data not including visual data). In some examples, the third content is an efficiently updated content (e.g., compressed data and/or data with a threshold of staleness). In some examples, in response to detecting the second respective state of the respective computer system and in accordance with a determination that the third set of one or more criteria and the fourth set of one or more criteria are satisfied, the first computer system updates the first content and the second content.

In some examples, updating the content includes sending a request for updated content (e.g., the content and/or a different content from the content) (e.g., static content stored on a CDN, cached content, and/or real-time content in one or more servers, and/or content stored on one or more durable storage mediums (e.g., disk, hard drive, SSD, and/or database)) to another computer system (e.g., one or more computer systems, servers, databases, caches, hosted APIs, and/or cloud computers) different from the first computer system and the second computer system. In some examples, the first computer system combines (e.g., aggregates, and/or computes) locally stored data and fetched data from the other computer system to update (e.g., generate and/or refresh) the content.

Note that details of the processes described above with respect to method 1100 (e.g., FIG. 11) are also applicable in an analogous manner to other methods described herein. For example, method 1300 optionally includes one or more of the characteristics of the various methods described above with reference to method 1100. For example, the first computer system of method 1300 is the second computer system of method 1100. For brevity, these details are not repeated herein.

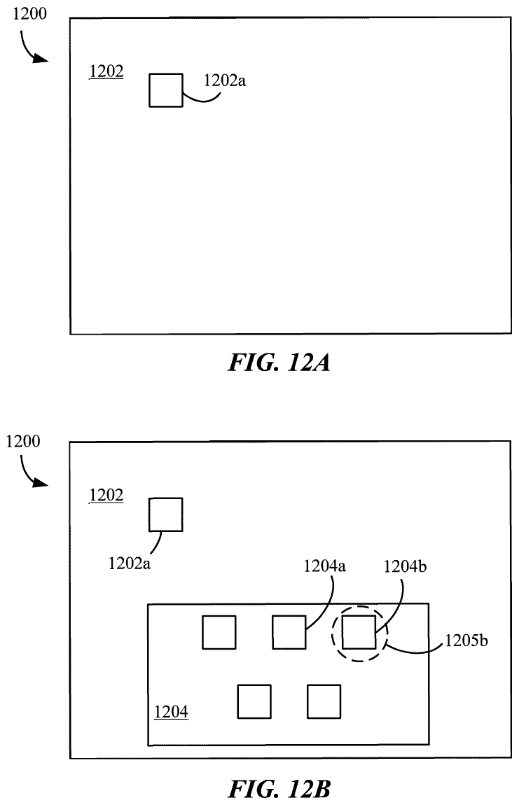

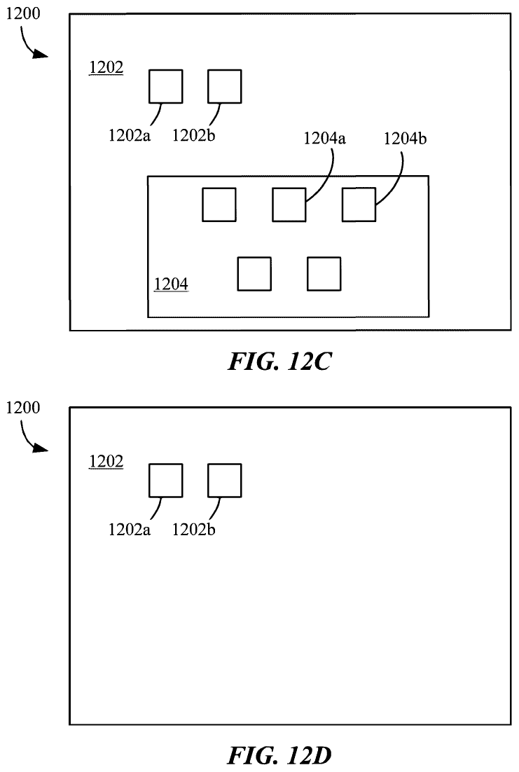

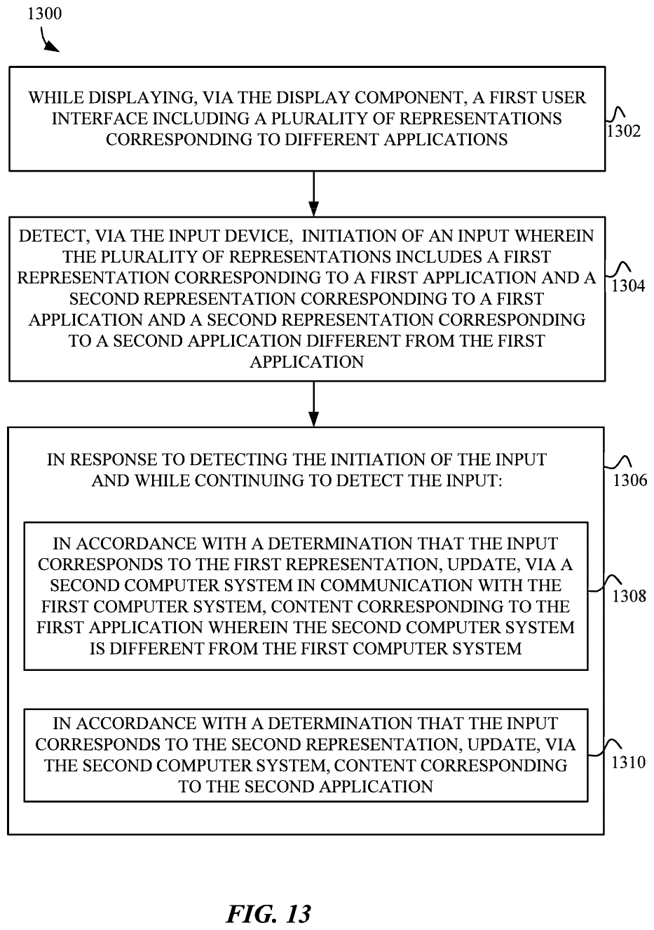

FIGS. 12A-12D illustrate exemplary user interfaces for updating content on a remote device in accordance with some examples. The user interfaces in these figures are used to illustrate the processes described below, including the processes described with respect to FIG. 13.

FIGS. 12A-12D is described with respect to the context above of remote device 1200 (e.g., first remote device 310, second remote device 320, and/or remote device 404) obtaining content for an archive of an application from a source device (e.g., source device 300 and/or source device 402). In some examples, the application is executing on the source device without a corresponding application executing on remote device 1200. In other examples, the application is executing on the source device while a corresponding application is executing on remote device 1200. While many operations are described below with respect to remote device 1200 performing such operations, it should be recognized that a process of remote device 1200 can perform one or more operations. For example, a system process (e.g., an operating system process and/or a background process) of remote device 1200 can perform an operation on behalf of the corresponding application and/or one or more applications of the source device including the application that corresponds to the archive. For another example, the corresponding application can perform one or more operations.

As illustrated in FIGS. 12A-12D, desktop user interface 1202 serves as a central place for accessing and/or managing user interface elements such as widgets, applications, files, folders, media, and/or navigation controls among other user interface elements. Desktop user interface 1202 allows a user to access applications, view notifications, switch between applications, and/or personalize their desktop experience by including a customizable background space where a user can arrange and/or organize the user interface elements according to their preferences. For example, a user can choose to place frequently accessed user interface elements in prominent locations on desktop user interface 1202 for quick access, while moving less frequently accessed user interface elements to other locations and/or removing them from desktop user interface 1202. The user interface elements include widgets that can display real-time information, folders and files for storing data, icons and shortcuts for launching applications, a menu bar for accessing device features and/or settings, and/or controls for navigating to other user interfaces, such as widget adding user interface 1204, a widget user interface (e.g., user interface of widget 1202a), an application user interface, and/or web browser.

As illustrated in FIG. 12A, desktop user interface 1202 includes one or more widgets, such as widget 1202a. In some examples, a widget is an interactive graphical user interface element that provides quick access to its corresponding application's information and/or functionality without the need to access the application's user interface. In some examples, a widget can display real-time data, such as weather updates, calendar events, news headlines, and/or other relevant user information directly on the desktop user interface. This allows a user to glance at and/or interact with widget content corresponding to an application without the need to navigate away from desktop user interface 1202 and/or open the application. For example, widget 1202a can be a weather widget that displays current weather conditions such as temperature, wind speed, precipitation, and/or forecast for a user's location. By having the weather widget on desktop user interface 1202, the user can seamlessly check the weather without opening a dedicated weather application the widget corresponds to.

At FIG. 12A, while displaying desktop user interface 1202, remote device 1200 can detect a set of one or more user inputs to navigate to another user interface, such as widget adding user interface 1204 (as illustrated in FIG. 12B). In some examples, widget adding user interface 1204 can be accessed through different manners such as one or more mouse clicks, keyboard shortcut, and/or selecting an option from a menu on desktop user interface 1202. The specific manner of accessing widget adding user interface 1204 can vary depending on the operating system of the remote device and/or user preferences. In some examples, widget adding user interface 1204 is an overlay on top of desktop user interface 1202, allowing the user to interact with the available widgets while maintaining a view of and/or access to desktop user interface 1202. In some examples, widget adding user interface 1204 includes widgets (e.g., widget 1204a and/or widget 1204b) that the user can browse, search, and/or select from to add to desktop user interface 1202.

In some examples, one or more widgets included in widget adding user interface 1204 correspond to different applications installed on (e.g., stored on, executing on, and/or available on) remote device 1200 and/or the source device. For example, widget 1204a corresponds to a first application and widget 1204b corresponds to a second application that is different from the first application. In some examples, widget adding user interface 1204 includes widgets not installed on remote device 1200 and/or the source device. In other examples, widget adding user interface 1204 does not include widgets of applications not installed on remote device 1200 and/or the source device.

As illustrated in FIG. 12B, while displaying widget adding user interface 1204, remote device 1200 detects initiation of input 1205b on widget 1204b. In some examples, input 1205b represents a sequence of interactions such as a tap input followed by a hold input and/or a hold input followed by a drag input directed at a location on desktop user interface 1202. For example, a user can tap on a widget (e.g., widget 1204b or widget 1204a) and hold the widget to select it, then drag the widget from widget adding user interface 1204 to a location on desktop user interface 1202. This sequence of interactions allows the user to seamlessly add the widget to remote device 1200 and display it on desktop user interface 1202.

In some examples, as the user continues input 1205b, remote device 1200 can move selected widget 1204b around widget adding user interface 1202 and/or desktop user interface 1204. The widget can follow the path of input 1205b, providing a visual indication of where it will be placed. The user can drag the widget to different locations on desktop user interface 1202 while existing user interface elements may be rearranged to accommodate newly added widget 1204b.

In some examples, in response to and/or immediately after detecting the initiation of input 1205b and while continuing to detect input 1205b, remote device 1200 proactively synchronizes and/or updates content corresponding to widget 1204b. For example, remote device 1200 begins updating the widget's content as soon as a user starts interacting with widget 1204b. In some examples, the content update and/or synchronization occurs before completion of input 1205b and/or before detecting any further interactions following input 1205b, such as a request to add widget 1204b to desktop user interface 1202 and/or dismissing widget adding user interface 1204. For example, if widget 1204b is a calendar widget, initiating input 1205b triggers remote device 1200 to synchronize the latest calendar events, appointments, and/or reminders from the source device. This ensures that once the calendar widget is added to desktop user interface 1202, widget 1204b includes the most current and/or accurate information.

In some examples, updating the content corresponding to widget 1204b includes synchronizing the latest data, files, multimedia content, graphical elements, and/or configurations between the source device and remote device 1200. For example, the synchronization ensures that the most up-to-date information is available on remote device 1200 to reflect any changes made to content corresponding to the widget on the source device. The synchronization can be performed via a short-range communication channel, such as Bluetooth, NFC, and/or Wi-Fi.

In some examples, updating the content corresponding to the widget can occur multiple times before completion of input 1205b (e.g., release of input 1205b). The multiple updates can be performed automatically on a background thread and/or process that does not require any user request for update.

In some examples, the updated content is not visible on widget 1204b while detecting input 1205b. Remote device 1200 can update the underlying data, files, and/or configurations without rendering updated graphical elements until completion of input 1205b, such as having added the widget to desktop user interface 1202 where the widget is ready for access and/or user interactions. For example, a user initiates input on a weather widget in widget adding user interface 1204, triggering remote device 1200 to synchronize latest weather data from the source device. The synchronization includes updating the widget's content with most recent information, such as latest user locations and/or new weather conditions. If the user completes input 1205b by adding the weather widget to desktop user interface 1202, the widget (e.g., widget 1202b) will then include display of the synchronized content with updated visual elements, providing an up-to-date view of the weather information across the source device and remote device 1200 once the weather widget is available on desktop user interface 1202. In other examples, the updated content is visible on widget 1204b (e.g., within desktop user interface 1202 and/or widget adding user interface 1204) while input 1205b is continued to be detected.

As illustrated in FIG. 12C, input 1205b is completed with a request to add a widget corresponding to widget 1204b (referred to herein as widget 1202b) to desktop user interface 1202. This request is triggered by the user releasing the input at a location on desktop user interface 1202.

In some examples, while detecting input 1205b and/or after detecting release of the input, existing user interface elements of desktop user interface 1202 are rearranged to accommodate the newly added widget 1202b. This may involve shifting positions of other widgets, and/or resizing user interface elements to create space for widget 1202b at the location that the user releases the input on. For example, widget 1202b is added to desktop user interface 1202 in a grid layout, positioned adjacent to and aligning horizontally with widget 1202a, as illustrated in FIG. 12C.

As illustrated in FIG. 12D, widget adding user interface 1204 has been minimized and/or dismissed. In some examples, widget adding user interface 1204 can be minimized and/or dismissed through different manners such as automatically after a period of inactivity and/or through a user input such as clicking a close button, pressing a keyboard shortcut, and/or selecting a menu option. The specific manner for minimizing and/or dismissing the widget adding user interface can vary depending on the operating system of the remote device, and/or user preferences. Also illustrated in FIG. 12D, widget 1202b is persistent on desktop user interface 1202, included as part of desktop user interface 1202 after detecting release of input 1205b. Remote device 1200 and/or a management process of desktop user interface 1202 now manages its display and/or access to its content independently of widget adding user interface 1204 and/or an application corresponding to widget 1202b.

As mentioned earlier, the content of widget 1202b is obtained while detecting input 1205b. The user can now interact with widget 1202b directly on desktop user interface 1202, accessing its content and/or features without the need to open the widget's corresponding application and/or navigate away from desktop user interface 1202. For example, if widget 1202b is a calendar widget, the user can now immediately glance at up-to-date events, view details of appointments previously created on the source device, and/or add new events directly from widget 1202b displayed on desktop user interface 1202.

In some examples, the integration of widget 1202b into desktop user interface 1202 enhances the user's workflow by providing quick access to synchronized content and/or information of widgets across devices. The proactive synchronization ensures that widget 1202b immediately displays up-to-date and consistent content, eliminating the need for manual updates and/or delays in accessing information that can result from a delayed content update, such as waiting until widget 1202b is added to desktop user interface 1202 to perform the content update.

FIG. 13 is a flow diagram illustrating a method (e.g., method 1300) for updating content on a remote device in accordance with some examples. Some operations in method 1300 are, optionally, combined, the orders of some operations are, optionally, changed, and some operations are, optionally, omitted.

As described below, method 1300 provides an intuitive way for updating content on a remote device. Method 1300 reduces the cognitive burden on a user, thereby creating a more efficient human-machine interface. For battery-operated computing devices, enabling a user to interact with such devices faster and more efficiently conserves power and increases the time between battery charges.

In some examples, method 1300 is performed at a first computer system (e.g., a smart phone, a smart watch, a smart display, a tablet, a laptop, a fitness tracking device, a head-mounted display (HMD) device, a communal device, a media device, a speaker, a television, and/or a personal computing device) (e.g., 310, 320, 404, and/or 1200) in communication with a display generation component (e.g., a display screen, a projector, and/or a touch-sensitive display) and an input component (e.g., a camera, a depth sensor, a microphone, a hardware input mechanism, a rotatable input mechanism, a heart monitor, a temperature sensor, and/or a touch-sensitive surface).

While displaying, via the display generation component, a first user interface (e.g., a widget-adding user interface and/or a widget application store) (e.g., 1204) including a plurality of representations (e.g., 1204a and/or 1204b) corresponding to different applications (e.g., graphical components, dynamic elements, widgets, and/or application shortcuts) (e.g., to be added (e.g., to personalize display and/or to customize placement within the second user interface described below) to the second user interface (e.g., to be displayed by the first computer system via the display generation component)), the first computer system detects (1302), via the input component, initiation of an input (e.g., a drag input, a hold-and-drag input, a verbal input, an audible request, an audible command, an audible statement, a swipe input, a gaze input, an air gesture, and/or a mouse click) (e.g., 1205b), wherein the plurality of representations includes a first representation (e.g., a first widget) (e.g., 1204a) corresponding to a first application and a second representation (e.g., the same as or different from the first representation) (e.g., 1204b) corresponding to a second application (e.g., a second widget) different from the first application.

In response to (1304) (and/or after) detecting the initiation of the input and while continuing to detect the input (e.g., before detecting a request to add a representation of the plurality of representations and/or content corresponding to the representation to the second user interface of the first computer system), in accordance with a determination that the input corresponds to the first representation, the first computer system updates (1306) (e.g., refreshes to the latest state, fetches, downloads, aggregates, transforms, and/or retrieves data) (e.g., in the background, and/or in the foreground), via a second computer system (e.g., a smart phone, a smart watch, a smart display, a tablet, a laptop, a fitness tracking device, a head-mounted display (HMD) device, a communal device, a media device, a speaker, a television, and/or a personal computing device) (e.g., 300 and/or 402) in communication with the first computer system, content (e.g., data, files, records, parameters, and/or configurations) corresponding to the first application (e.g., with or without updating an appearance of the first representation) (e.g., without updating content corresponding to the second application) (e.g., as described above with respect to FIG. 12B), wherein the second computer system is different (and/or separate) from the first computer system. In some examples, updating the content corresponding to the first application includes synchronizing (e.g., matching, regenerating, and/or localizing) a state (e.g., data, files, records, parameters and/or configurations) of the content with a state (e.g., latest state and/or real-time state) stored by the second computer system.

In response to (1304) detecting the initiation of the input and while continuing to detect the input, in accordance with a determination that the input corresponds to the second representation, the first computer system updates (1308), via the second computer system, content (e.g., data, files, records, parameters, and/or configurations) corresponding to the second application (e.g., with or without updating an appearance of the second representation) (e.g., without updating content corresponding to the first application) (e.g., as described above with respect to FIG. 12B).

In some examples, after detecting the initiation of the input, the first computer system detects release (e.g., end and/or termination) of the input. In some examples, in response to detecting the release of the input, in accordance with a determination that the input corresponds to the first representation, the first computer system displays, via the display generation component, a third representation (e.g., 1202b) corresponding to the first application on (and/or in) a second user interface (e.g., 1202) different from the first user interface (e.g., home screen, application list, and/or shortcut view). In some examples, the third representation is the same representation as the first representation (e.g., both representations are widgets and/or shortcuts of the first application). In some examples, the third representation is a different representation from the first representation (e.g., the third representation is a widget, and the first representation is an icon). In some examples, in response to detecting the release of the input, in accordance with a determination that the input corresponds to the second representation, the first computer system displays, via the display generation component, a fourth representation corresponding to the second application on (and/or in) the second user interface. In some examples, the fourth representation is the same representation as the second representation (e.g., both representations are widgets and/or shortcuts of the second application). In some examples, the fourth representation is a different representation from the third representation (e.g., the fourth representation is a widget, and the second representation is an application).

In some examples, in response to detecting the release of the input, in accordance with a determination that the input corresponds to the first representation and that the input was released at a location corresponding to the second user interface (e.g., at any point on the second user interface and/or at a specific point in the second user interface), the first computer system displays, via the display generation component, a fifth representation (e.g., 1202b) corresponding to the first application on (and/or in) the second user interface. In some examples, in response to detecting the release of the input and in accordance with a determination that the input corresponds to the second representation and that the input was released at a location corresponding to the second user interface, the first computer system displays, via the display generation component, a sixth representation corresponding to the second application on (and/or in) the second user interface. In some examples, in response to detecting the release of the input, in accordance with a determination that the input corresponds to the first representation and that the input was not released at a location corresponding the second user interface (and/or that the input was released at a location corresponding to the first user interface and/or another user interface different from the first user interface and the second user interface), the first computer system forgoes display, via the display generation component, of the fifth representation corresponding to the first application (e.g., on (and/or in) the second user interface). In some examples, in response to detecting the release of the input and in accordance with a determination that the input corresponds to the second representation and that the input was not released at a location corresponding to the second user interface, the first computer system forgoes display of, via the display generation component, the sixth representation corresponding to the second application (e.g., on (and/or in) the second user interface).

In some examples, the input is a hold-and-drag input (e.g., the input starts at a first location and is continued to be detected as the input moves to a second location different from the first location).

In some examples, updating the content corresponding to the first application (and/or the second application) includes: sending a request (e.g., for one or more updates to the content) to another computer system (e.g., the second computer system and/or another computer system different from the second computer system) different from the first computer system; and after sending the request to the other computer system, receiving the updated content from the other computer system (e.g., via one or more intermediary servers, via one or more network calls, via the other device's cache and/or storage, and/or via one or more databases) (e.g., as a response to the request).

In some examples, the request is sent to the other computer system and the updated content is received from the other computer system via a short-range communication channel (e.g., Bluetooth, BLE, NFC, Zigbee, Ultra-Wideband, and/or Wi-Fi). In some examples, the request is sent to the other computer system or the updated content is received from the other computer system via a short-range communication channel.

In some examples, the different applications are installed on (e.g., stored in, running on (e.g., in the background and/or foreground), and/or deployed in) another computer system (e.g., the second computer system that is paired with the first computer system) different from the first computer system. In some examples, the different applications include one or more applications not installed on the first computer system. In some examples, the different applications include one or more applications installed on the first computer system.

In some examples, the first user interface does not include a representation of an application (e.g., a widget or another type of application) not installed on the other computer system. In some examples, the first user interface does not include a representation of an application installed on the first computer system and not installed on the other computer system. In some examples, the first user interface includes a representation of an application not installed on the first computer system and/or the second computer system.

In some examples, the first user interface includes a representation of an application (e.g., a widget or another type of application) installed on (e.g., stored in, running on (e.g., in the background and/or foreground), and/or deployed in) the other computer system.

In some examples, after detecting the initiation of the input and while continuing to detect the input, the first computer system updates (e.g., fetch data from one or more computer systems, process, transform, and/or aggregate content) (e.g., in the background, and/or in real-time), via the second computer system, the content a plurality of separate times (e.g., before detecting release of the input). In some examples, updating, via the second computer system, the content the plurality of separate times includes performing one or more update steps (e.g., of a structured process), performing one or more network calls, and/or one or more transformation steps of the content.

In some examples, the updated content (e.g., corresponding to the first application and/or the second application) is not displayed via the display generation component while detecting the input. In some examples, after (and/or in response to) detecting the release of the input (and/or after and/or in response to) (e.g., adding a sixth representation corresponding to the first application and/or the second application on (and/or to) a second user interface (e.g., of the second computer system) different from the first user interface), the first computer system displays, via the display generation component, the updated content. In some examples, the updated content is content that can only be displayed on and/or by the first application and/or the second application (e.g., the content requires the first application and/or the second application to be rendered and/or can only be rendered in an environment of the sixth representation, the first application, and/or the second application).

In some examples, updating the content corresponding to the first application includes updating display (e.g., adding visual components, updating values populating visual components, and/or rendering real-time data), via the display generation component, of a seventh representation (e.g., the first representation or another representation different from the first representation) of the first application (e.g., to include the updated content) (e.g., as described above with respect to FIG. 12B). In some examples, updating the content corresponding to the second application includes updating display of an eighth representation (e.g., the second representation or another representation different from the second representation) of the second application.

In some examples, in response to (and/or after) detecting the initiation of the input, while continuing to detect the input, and in accordance with a determination that the input corresponds to the first representation, the first computer system displays (e.g., continuously updating display of, and/or adjusting display of), via the display generation component, the seventh representation (e.g., including the updated content) of the first application moving with the input (e.g., as the input moves). In some examples, in response to (and/or after) detecting the initiation of the input, while continuing to detect the input, and in accordance with a determination that the input corresponds to the second representation, the computer system displays (e.g., continuously updating display of, and/or adjusting display of), via the display generation component, the eighth representation (e.g., including the updated content) of the second application moving with the input (e.g., as the input moves).

Note that details of the processes described above with respect to method 1300 (e.g., FIG. 13) are also applicable in an analogous manner to other methods described herein. For example, method 1100 optionally includes one or more of the characteristics of the various methods described above with reference to method 1300. For example, the content of method 1300 is the content of method 1100. For brevity, these details are not repeated herein.

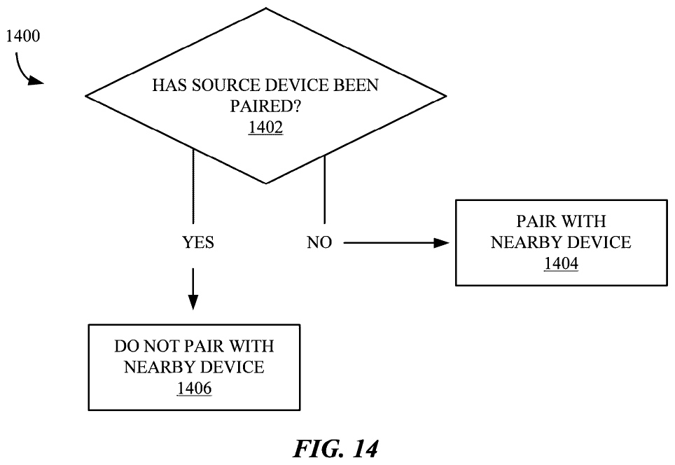

FIG. 14 is a flow diagram illustrating a process (e.g., process 1400) for a source device to automatically pair with a nearby device in accordance with some examples. Some operations in process 1400 are, optionally, combined, changed, and/or omitted.

In some examples, process 1400 corresponds to pairing via a remote content protocol for allowing a source device (e.g., source device 402 or source device 300) to provide content to a remote device (e.g., remote device 404, first remote device 310, and/or second remote device 320) for display by the remote device as described above. The pairing via the remote content protocol can be different from pairing via another protocol, such as a media pairing for a headset, earphones, and/or speakers. In some examples, the pairing via the remote content protocol and the media pairing can both be for a Bluetooth connection but be used for communicating different data. For example, the remote content protocol can be used to synchronize archives as discussed above while the media pairing can be used to send media data for output. In some examples, the remote content protocol bypasses a set of one or more security requirements to enable a streamlined pairing process with nearby devices and is different from other pairing protocols including a media pairing protocol.

In some examples, process 1400 is performed by a system process (e.g., an operating system process and/or a background thread) that is different from one or more applications executing and/or installed on the source device.

In some examples, process 1400 begins with the source device receiving a message from a remote device. In such examples, the message can be received while the source device is passively or actively scanning its environment to detect the presence of nearby devices. In some examples, the message is an ambient message that is received via a short-range communication channel (e.g., Bluetooth) to broadcast presence and/or identity of the remote device. In some examples, the remote device sends the ambient message without initiation and/or detection of user input and/or without the source device sending a request to the remote device. The message can include information about the remote device, such as its name, identification (e.g., a MAC address, a UUID, a hash, a unique device signature, a SSID, and/or an IP address), timestamp of the message, compatibility data, and other metadata relevant to the remote content protocol. This information can allow the source device to efficiently recognize nearby devices that are available for pairing once the source device is in a state that allows for pairing.

At 1402, in response to and/or after receiving the message, the source device determines whether the source device is paired with another device for the remote content protocol. In the case that the source device is already paired with another device for the remote content protocol (e.g., whether the source device is currently in communication with or not in communication with another device), the first device ignores the message and proceeds to step 1406 (e.g., does not automatically pair with the remote device for the remote content protocol). In this case, the source device requires an explicit user request to pair with the remote device for the remote content protocol. For example, a user can request pairing with the remote device via a settings user interface on the source device. In the case that the source device is not paired with another device, the first device proceeds to step 1404 to automatically pair with the remote device, thereby enabling a streamlined pairing process without requiring manual input from a user.

At 1404, the source device initiates the pairing process with the remote device. At this point in time, the source device is not paired with another device and the remote device was determined to be in proximity with the source device. In some examples, the source device chooses the first device that was determined to be in proximity with the source device to automatically pair with. In some examples, the source device starts pairing once a display of the source device becomes active (e.g., the screen is on). For example, the source device can initiate a network browser to discover nearby devices. In such an example, the source device can leverage information in the message from the remote devices to identify the remote device using the network browser.

In some examples, pairing involves establishing a long-term cryptographic key between the two devices. The long-term cryptographic key can serve as a unique identifier and/or a secure token that enables the two devices to recognize and authenticate each other in future interactions. By exchanging the long-term cryptographic key during the pairing process, the two devices create a trusted connection that allows for a streamlined secure communication going forward. In addition to the long-term cryptographic key, the pairing process can involve setting a pairing status data on both devices. This pairing status data includes information such as the paired device's name, identification signature, supported protocol versions, and/or other relevant metadata. By storing the pairing status data and the long-term cryptographic key, the two devices can maintain a record of their pairing relationship, allowing for efficient and secure communication by reducing friction and overhead of establishing a new secure connection each time they need to interact and/or communicate.

In some examples, the message received from the remote device includes a hash of data stored by the remote device. The hash of the data can help protect data stored by the remote device by creating a unique fingerprint of the data without revealing actual content. In some examples, the hash of the data includes an identification of a set of one or more extensions and/or widgets corresponding to a set of one or more applications of the remote device (e.g., as described above). In another example, the hash of the data includes a set of one or more icons corresponding to a set of one or more applications of the remote device (e.g., hash of visual elements, resolutions, and/or file data of the one or more icons). By including this information, the source device can determine content shared by the source device to the remote device, enabling the source device to customize the user experience after pairing, automatically configure settings, enable relevant features, suggest appropriate actions based on the available extensions, and/or proactively store data needed to facilitate subsequent actions and/or communications with the remote device.

In some examples, after pairing with the remote device, the source device uses (e.g., stores, processes, and/or decodes) the hash of the data (e.g., via an intermediary server, and/or locally) to synchronize content (e.g., icons, graphical elements, multimedia content, real-time user data, sensor data, and/or system configurations) with the remote device as described above.

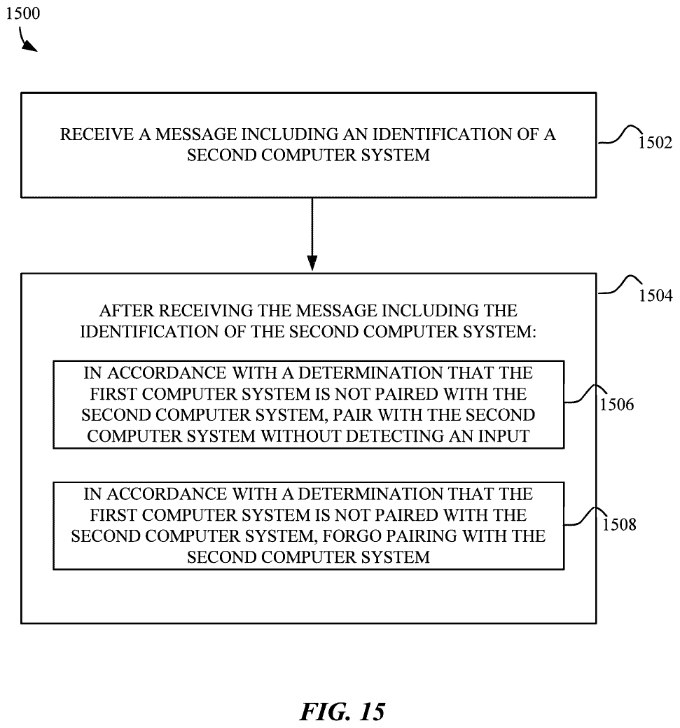

FIG. 15 is a flow diagram illustrating a method (e.g., method 1500) for a source device to automatically pair with a nearby device in accordance with some examples. Some operations in method 1500 are, optionally, combined, the orders of some operations are, optionally, changed, and some operations are, optionally, omitted.

As described below, method 1500 provides an intuitive way for a source device to automatically pair with a nearby device. Method 1500 reduces the cognitive burden on a user, thereby creating a more efficient human-machine interface. For battery-operated computing devices, enabling a user to interact with such devices faster and more efficiently conserves power and increases the time between battery charges.

In some examples, method 1500 is performed at a first computer system (e.g., a smart phone, a smart watch, a smart display, a tablet, a laptop, a fitness tracking device, a head-mounted display (HMD) device, a communal device, a media device, a speaker, a television, and/or a personal computing device) (e.g., 300 and/or 402).

The first computer system receives (1502) a message (e.g., a wireless communication, a network message, a hash, a signal, a payload, and/or a communication packet) including an identification (e.g., name, serial number, a MAC address, an IP address, a device ID, a user ID, a user account ID, a token, a signature, and/or UUID) of a second computer system (e.g., a smart phone, a smart watch, a smart display, a tablet, a laptop, a fitness tracking device, a head-mounted display (HMD) device, a communal device, a media device, a speaker, a television, and/or a personal computing device) (e.g., 310, 320, and/or 404) different from the first computer system.

After (1504) (and/or in response to) receiving the message including the identification of the second computer system (and, in some examples, without detecting user input), in accordance with a determination that the first computer system is not paired (e.g., connected, associated, linked, configured, registered, and/or synchronized) with another computer system (e.g., the second computer system, a third computer system different from the first computer system and the second computer system, and/or any other computer system) (and, in some examples, that the second computer system is the nearest computer system to the first computer system) (e.g., as described above with respect to 1402), the first computer system automatically pairs (1506) (e.g., establishes a connection and/or long-term key for communicating, associates, links, configures, registers, and/or synchronizes) (e.g., via a particular protocol, such as a remote widget (and/or content) protocol that uses data from another computer system (e.g., the second computer system) to present information via the first computer system) with the second computer system without detecting a user input (e.g., a physical interaction, voice command, gesture, sensor activation, and/or manual user intervention) corresponding to a request to pair with the second computer system (e.g., as described above with respect to 1404). In some examples, after (and/or in response to) receiving the message including the identification of the second computer system and in accordance with a determination that the first computer system is not paired with another computer system, the first computer system outputs (e.g., via a display, audio, and/or haptic generation component) an indication corresponding to the second computer system. In some examples, after (and/or while) outputting the indication corresponding to the second computer system, the first computer system detects user input corresponding to a request to pair with the second computer system. In some examples, in response to detecting the user input corresponding to the request to pair with the second computer system, the first computer system pairs with the second computer system after detecting an input (e.g., a tap input and/or a non-tap input (e.g., a verbal input, an audible request, an audible command, an audible statement, a swipe input, a hold-and-drag input, a gaze input, an air gesture, and/or a mouse click)). In some examples, the first computer system automatically pairing with the second computer system establishes a direct connection (e.g., based on Bluetooth, Wi-Fi, NFC, and/or custom pairing protocols) between the two computer systems. In some examples, the first computer system automatically pairing with the second computer system is initiated based on proximity, device discovery, shared network, and/or user configuration. In some examples, the first computer system automatically pairing with the second computer system enables data sharing, feature synchronization, and/or control delegation.

After (1504) receiving the message including the identification of the second computer system, in accordance with a determination that the first computer system is paired (e.g., connected, associated, linked, configured, registered, and/or synchronized) with another computer system (e.g., the second computer system, a third computer system different from the first computer system and the second computer system, and/or any other computer system), the first computer system forgoes (1508) automatically pairing with the second computer system (e.g., as described above with respect to 1406).

In some examples, automatically pairing with the second computer system includes establishing (e.g., sharing, and/or agreeing on) (e.g., via a network browser) a long-term key (e.g., cryptographic, session, token-based, security, and/or authentication key) with the second computer system. In some examples, the first computer system establishes a long-term key before pairing with the second computer system.

In some examples, automatically pairing with the second computer system is performed in response to detecting that the first computer system is in a first display state (e.g., active display) (e.g., in a locked or unlocked state). In some examples, the first computer system automatically pairs with the second computer system after and/or in response to detecting that the second computer system is in the first display state or another state different from the first display state. In some examples, the first computer system forgoes automatically pairing with the second computer system in response to and/or while detecting that the first computer system is in a second display state (e.g., inactive or off display) (e.g., in a locked or unlocked state) different from the first display state. In some examples, the first computer system forgoes automatically pairing with the second computer system in response to and/or while detecting that the second computer system is in the second display state.

In some examples, the message, including the identification of the second computer system, includes a hash of data (e.g., encrypted data and/or compressed data) (e.g., the data includes identification information of a user and/or of the second computer system and/or a network name, a password, and/or a nonce value) (e.g., the data and/or the hash of the data is stored on the second computer system). In some examples, the first computer system verifies and/or processes the hash of the data before automatically pairing with the second computer system. In some examples, the first computer system uses (e.g., extracts data, stores, and/or processes) one or more portions of the hash of the data to automatically pair with the second computer system. In some examples, the first computer system uses (e.g., stores, and/or processes) one or more portions of the hash of the data after (e.g., during and/or while) automatically pairing with the second computer system (e.g., to synchronize content with the second computer system (e.g., the hash indicates what data that the second computer system already has)).

In some examples, the data of the hash of data includes an identification of a set of one or more extensions (e.g., the list of stored (e.g., installed) modules and/or environment information of the second computer system) corresponding to a set of one or more applications of the second computer system. In some examples, the first computer system uses (e.g., stores, and/or processes) one or more portions of the identification of the set of one or more extensions after (e.g., during, and/or while) automatically pairing with the second computer system (e.g., to send content corresponding to the set of one or more extensions to the second computer system without sending content to another set of one or more extensions different from the set of one or more extensions).

In some examples, the data of the hash of the data includes a set of one or more icons (e.g., images, SVGs, files, vector representations, hashed visual representations, and/or custom binary formats) (e.g., a set of one or more visual representations) corresponding to a set of applications of the second computer system. In some examples, the first computer system uses (e.g., stores, and/or processes) one or more portions of the set of one or more icons after (e.g., during, and/or while) automatically pairing with the second computer system (e.g., to identify which icons that the second computer system does not have so that the first computer system can send the icons to the second computer system).

In some examples, after receiving the message including the identification of the second computer system and before automatically pairing with the second computer system, the first computer system receives, via a third computer system different from the first computer system and the second computer system, another message, different from the message, including an identification of the third computer system, wherein the first computer system does not automatically pair with the third computer system as a result of the first computer system receiving the other message after receiving the message. In some examples, the other message received from the third computer system includes a hash of data. In some examples, the other message includes an identification of a set of one or more extensions corresponding to a set of one or more applications of the third computer system. In some examples, the other message includes a set of one or more icons corresponding to a set of applications of the third computer system. In some examples, the other message includes a request to pair with the third computer system. In some examples, the third computer system is not automatically paired with by the first computer system as a result of the first computer system detecting the second computer system before detecting the third computer system.

In some examples, the first computer system is in communication with an input component (e.g., a camera, a depth sensor, a microphone, a hardware input mechanism, a rotatable input mechanism, a heart monitor, a temperature sensor, and/or a touch-sensitive surface). In some examples, after automatically pairing with the second computer system, the first computer system detects, via the input component, an input (e.g., a tap input and/or a non-tap input (e.g., a verbal input, an audible request, an audible command, an audible statement, a swipe input, a hold-and-drag input, a gaze input, an air gesture, and/or a mouse click)) corresponding to a request to pair with a fourth computer system different from the first computer system and the second computer system. In some examples, in response to detecting the input corresponding to the request to pair with the fourth computer system, the first computer system unpairs (e.g., disconnecting from, terminating link with, and/or de-authenticating) with the second computer system. In some examples, the first computer system maintains the long-term key established with the second computer system. In some examples, the first computer system invalidates (e.g., deletes) the long-term key established with the second computer system. In some examples, in response to detecting the input corresponding to the request to pair with the fourth computer system, the first computer system pairs with the fourth computer system.

In some examples, after automatically pairing with the second computer system, the first computer system obtains (e.g., requests and, as a result receives), from the second computer system, via a communication channel corresponding to (and/or established via) the automatic pairing, content (e.g., corresponding to the message (e.g., including a hash of data) (e.g., content that can be fetched and/or computed based on (e.g., requiring data in) the message, content identified with (e.g., hashed in, stored using data in) the message, and/or content received via a network call with a portion of the message as a parameter)) (e.g., as described above with respect to method 1100) (e.g., 512 and/or 514). In some examples, the communication channel is established using the hash of the data described above. In some examples, the content is identified using the hash of the data described above.

In some examples, after obtaining the content (e.g., corresponding to the message (e.g., including a hash of data)), the second computer system displays a representation (e.g., 1202b) of the content (e.g., populated with the content, and/or represents one or more portions of the content) (e.g., widget, application and/or shortcut) (e.g., on and/or in a user interface (e.g., a desktop, a list of widgets, and/or a list of applications) of the first computer system).

Note that details of the processes described above with respect to method 1500 (e.g., FIG. 15) are also applicable in an analogous manner to the methods described herein. For example, method 1200 optionally includes one or more of the characteristics of the various methods described herein with reference to method 1500. For example, the first computer system of method 1500 is the first computer system of method 1100. For brevity, these details are not repeated herein.

In some embodiments, one or more of the methods 700, 800, 900, 1000, 1100, 1300, 1400 and 1500 are performed at a first computer system via a system process (e.g., an operating system process) that is different from one or more applications executing and/or installed on the first computer system.

In some embodiments, one or more of the methods 700, 800, 900, 1000, 1100, 1300, 1400 and 1500 are performed at a first computer system by an application that is different from a system process. In some embodiments, the instructions of the application, when executed, control the first computer system to perform one or more of the methods 700, 800, 900, 1000, 1100, 1300, 1400 and 1500 by calling an application programming interface (API) provided by the system process. In some embodiments, the application performs at least a portion of the method without calling the API. In some embodiments, the application can be any suitable type of application, including, for example, one or more of: a browser application, a super-app that functions as an application execution environment for plug-ins, widgets or other applications, a fitness application, a health application, a digital payments application, a media application, a social network application, and the like. In some embodiments, the application is an application that is pre-installed on the first computer system at purchase (e.g., a First Party application). In some embodiments, the application is an application that is provided to the first computer system via an operating system update file (e.g., a First Party application). In some embodiments, the application is an application that is provided via an App Store. In some implementations, the App Store is an app store that is pre-installed on the first computer system at purchase (e.g., a First Party App Store). In some implementations, the App Store is a Third Party App Store (e.g., an app store that is provided by another app store, downloaded via a network, read from a storage device, etc.). In some embodiments, the application is a Third Party App (e.g., an app that is provided by an app store, downloaded via a network, read from a storage device, etc.). In some embodiments, the application controls the first computer system to perform one or more of the methods 700, 800, 900, 1000, 1100, 1300, 1400 and 1500 by calling an application programming interface (API) provided by the system process using one or more parameters. In some embodiments, exemplary APIs provided by the system process include one or more of: a Pairing API (e.g., for establishing secure connection) (e.g., with an accessory), a Device detection API (e.g., for locating nearby devices) (e.g., Apple TVs, other iPhones), a UIKit API (e.g., for generating user interfaces), a Location Detection API, a FindMy API, a Push Notification API, a Streaming API, an App Store API, a web browser API (e.g., WebKit API), a CarPlay API, a Networking API, a WiFi API, a Bluetooth API, an NFC API, a UWB API, a Fitness API, a HomeKit API, and the like. In some embodiments, at least one API is a software module (e.g., a collection of computer-readable instructions) that provides an interface that allows a different module (e.g., API calling module) to access and use one or more functions, methods, procedures, data structures, classes, and/or other services provided by an OS implementation module of the system process. The API can define one or more parameters that are passed between the API calling module and the OS implementation module. The OS implementation module is an operating system software module (e.g., a collection of computer-readable instructions) that is constructed to perform an operation in response to receiving an API call via the API. In some embodiments, the OS implementation module is constructed to provide an API response (via the API) as a result of processing an API call.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve how computer systems interact. The present disclosure contemplates that in some instances, this gathered data can include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to change how the computer systems interact. Accordingly, use of such personal information data enables better computer system interactions. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be displayed to computer systems by inferring data based on non-personal information data or a bare minimum amount of personal information, such as the content being requested by the computer system associated with a user or other non-personal information.

What is claimed is:

1. A method, comprising:
at a first computer system:
detecting a respective state of a second computer system different from the first computer system;
in response to detecting the respective state of the second computer system:
in accordance with a determination that a first set of one or more criteria is satisfied, updating content; and
in accordance with a determination that a second set of one or more criteria, different from the first set of one or more criteria, is satisfied, forgoing update of the content; and
after updating the content, sending, to the second computer system, the updated content for display by the second computer system.

2. The method of claim 1, wherein the content is a portion of a representation of an application of the second computer system.

3. The method of claim 2, wherein the first computer system is in communication with a display generation component, the method further comprising:
displaying, via the display generation component, the content.

4. The method of claim 2, wherein the updated content is not displayed by the first computer system.

5. The method of claim 1, wherein the respective state of the second computer system includes a distance of the second computer system from the first computer system, wherein the first set of one or more criteria includes a criterion that is satisfied when the distance is within a threshold distance, and wherein the second set of one or more criteria includes a criterion that is satisfied when the distance is not within the threshold distance.

6. The method of claim 1, wherein the respective state of the second computer system includes a display state of the second computer system, wherein the first set of one or more criteria includes a criterion that is satisfied when the display state is a first state, and wherein the second set of one or more criteria includes a criterion that is satisfied when the display state is a second state different from the first state.

7. The method of claim 1, wherein the respective state of the second computer system includes a configuration of an application corresponding to the content, wherein the first set of one or more criteria includes a criterion that is satisfied when the second computer system is configured with the application corresponding to the content, and wherein the second set of one or more criteria includes a criterion that is satisfied when the second computer system is not configured with the application corresponding to the content.

8. The method of claim 1, wherein detecting the respective state of the second computer system includes receiving a message from the second computer system.

9. The method of claim 1, wherein detecting the respective state of the second computer system includes sending a message including an identification of the first computer system.

10. The method of claim 9, wherein the first computer system is in communication with an input component, and wherein sending the message including the identification of the first computer system is performed without detecting, via the input component, an input.

11. The method of claim 1, wherein the content is updated in the background.

12. The method of claim 1, wherein the first set of one or more criteria includes a first criterion that is satisfied when the first computer system is in a first mode and the content was updated within a first predefined period of time, wherein the first set of one or more criteria includes a second criterion, different from the first criterion, that is satisfied when the first computer system is in a second mode, different from the first mode, and the content was updated within a second predefined period of time different from the first predefined period of time, and wherein the first set of one or more criteria is satisfied when either the first criterion or the second criterion is satisfied.

13. The method of claim 1, wherein the first set of one or more criteria includes a third criterion that is satisfied when the second computer system is in a third mode and the content was updated within a third predefined period of time, wherein the first set of one or more criteria includes a fourth criterion, different from the third criterion, that is satisfied when the second computer system is in a fourth mode, different from the third mode, and the content was updated within a fourth predefined period of time different from the third predefined period of time, and wherein the first set of one or more criteria is satisfied when either the third criterion or the fourth criterion is satisfied.

14. The method of claim 1, further comprising:
while the first set of one or more criteria is satisfied, continuing update of the content at a first rate.

15. The method of claim 1, further comprising:
while the first set of one or more criteria is satisfied:
in accordance with a determination that a third computer system is in a fifth mode, continuing update of the content at a second rate; and
in accordance with a determination that the third computer system is in a sixth mode, continuing update of the content at a third rate different from the second rate.

16. The method of claim 1, further comprising:
while the first set of one or more criteria is satisfied:
in accordance with a determination that the content is to be displayed by the first computer system, continuing update of the content at a fourth rate; and
in accordance with a determination that the content is not to be displayed by the first computer system, continuing update of the content at a fifth rate different from the fourth rate.

17. The method of claim 1, wherein the first set of one or more criteria includes a criterion that is satisfied when the content has not been updated within a predefined period of time.

18. The method of claim 1, wherein the content corresponds to a user interface, wherein the first set of one or more criteria includes a criterion that is satisfied when a number of views of the user interface on the second computer system exceeds a number threshold within a period of time.

19. The method of claim 1, wherein the updated content is not sent to the second computer system in response to updating the content.

20. The method of claim 1, wherein the respective state is a first respective state, wherein the content is first content, the method further comprising:
detecting a second respective state of a respective computer system different from the first computer system; and
in response to detecting the second respective state of the respective computer system:
in accordance with a determination that a third set of one or more criteria is satisfied, wherein the third set of one or more criteria includes a criterion that is satisfied when the respective computer system is a third computer system, updating second content; and
in accordance with a determination that a fourth set of one or more criteria, different from the third set of one or more criteria, is satisfied, wherein the fourth set of one or more criteria includes a criterion that is satisfied when the respective computer system is a fourth computer system different from the third computer system, updating third content different from the second content.

21. The method of claim 1, wherein updating the content includes sending a request for updated content to another computer system different from the first computer system and the second computer system.

22. A non-transitory computer-readable storage medium storing one or more programs configured to be executed by one or more processors of a first computer system, the one or more programs including instructions for:
detecting a respective state of a second computer system different from the first computer system;
in response to detecting the respective state of the second computer system:
in accordance with a determination that a first set of one or more criteria is satisfied, updating content; and
in accordance with a determination that a second set of one or more criteria, different from the first set of one or more criteria, is satisfied, forgoing update of the content; and
after updating the content, sending, to the second computer system, the updated content for display by the second computer system.

23. A first computer system, comprising:
one or more processors; and
memory storing one or more programs configured to be executed by the one or more processors, the one or more programs including instructions for:
detecting a respective state of a second computer system different from the first computer system;
in response to detecting the respective state of the second computer system:
in accordance with a determination that a first set of one or more criteria is satisfied, updating content; and
in accordance with a determination that a second set of one or more criteria, different from the first set of one or more criteria, is satisfied, forgoing update of the content; and
after updating the content, sending, to the second computer system, the updated content for display by the second computer system.
